(19) United States
(12) Patent Application Publication
(10) Pub. No.: US 2026/0291693 A1
(43) Pub. Date: Sep. 24, 2026

(54) TRANSMISSION TIME INTERVAL STRUCTURE FOR AMBIENT WIRELESS DEVICE COMMUNICATIONS

(71) Applicant: QUALCOMM Incorporated, San Diego, CA (US)

(72) Inventors: Zhikun WU, Beijing (CN); Ahmed ELSHAFIE, San Diego, CA (US); Yuchul KIM, San Diego, CA (US); Wei YANG, San Diego, CA (US); Huilin XU, Temecula, CA (US); Linhai HE, San Diego, CA (US)

(21) Appl. No.: 19/476,629

(22) PCT Filed: Jun. 15, 2023
(86) PCT No.: PCT/CN2023/100466

§ 371 Date: Oct. 17, 2025

(51) Int. Cl. H04L 5/00; H04W 4/80; H04W 72/0446

(52) U.S. Cl. CPC H04L 5/0092; H04W 4/80; H04W 72/0446

(57) ABSTRACT

Methods, systems, and devices for wireless communications are described. A network device (e.g., a user equipment (UE), a network entity) may configure a transmission time interval (TTI) structure for ambient wireless device communications. The TTI structure may include a set of TTIs allocated for a group of ambient wireless devices, such as a first TTI allocated for a continuous waveform and a second TTI allocated for a backscattered signal from the ambient wireless device. The network device may transmit an indication (e.g., a bitmap) of the TTI structure to the group of ambient wireless devices. An ambient wireless device may receive the TTI structure and, in the first TTI, the continuous waveform. The ambient device may send the backscattered signal in the second TTI. In some cases, the ambient wireless device may send the backscattered signal to a second network device (e.g., a reader) different from the network device.

### CROSS REFERENCE

The present Application is a 371 national phase filing of International PCT Application No. PCT/CN2023/100466 by WU et al., entitled “TRANSMISSION TIME INTERVAL STRUCTURE FOR AMBIENT WIRELESS DEVICE COMMUNICATIONS,” filed Jun. 15, 2023, which is assigned to the assignee hereof, and which is expressly incorporated by reference in its entirety herein.

### FIELD OF TECHNOLOGY

The following relates to wireless communications, including a transmission time interval (TTI) structure for ambient wireless device communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may include ambient devices, such as radio frequency identifier (RFID) tags or zero-power (ZP) Internet-of-Things (IoT) devices, to perform certain operations such as location tracking and identification. To communicate with an ambient device, a querying device (e.g., UE, network entity) may transmit a signal or query to the ambient device, and the ambient device may harvest energy from the signal or query to perform a read or write operation or to respond to the querying device. Ambient devices may include relatively low-complexity devices with limited resources and processing power.

### SUMMARY

The described techniques relate to improved methods, systems, devices, and apparatuses that support a transmission time interval (TTI) structure for ambient wireless device communications. For example, the described techniques provide a mechanism for organizing resources used for ambient wireless device communications. In particular, the described techniques support ambient wireless device occasions (e.g., allocated TTIs, such as slots, mini-slots, symbols, or the like) in which an ambient device and a network device (e.g., a user equipment (UE), a network entity) may communicate. The network device may configure a TTI structure that includes one or more TTIs allocated for ambient device communications. In some cases, the TTI structure may additionally include one or more TTIs allocated for uplink communications, downlink communications, or both uplink and downlink communications. In some examples, the TTI structure may include or be an example of a frame structure. For instance, a frame structure may include a set of slots, where the one or more TTIs allocated for ambient device communications include at least one slot. Additionally, or alternatively, the at least one slot may further include one or more symbols. Each symbol of the one or more symbols may be allocated for a respective communication direction (e.g., for communications between the ambient device and the network device). For example, a first symbol may be allocated for a continuous waveform from the network device and a second symbol may be allocated for a backscattered signal from the ambient device.

The network device may transmit an indication of the TTI structure to the ambient device. In some examples, the indication of the TTI structure may be a bitmap. In some cases, the network device may additionally indicate one or more subchannels allocated for the ambient wireless device communications, one or more subchannels allocated for the ambient wireless device, or a combination thereof. The ambient device may receive the TTI structure and a continuous waveform for activation of the ambient device. The ambient device may send, in a TTI (and, in some cases, via a subchannel) allocated for data from the ambient device according to the TTI structure, a backscattered signal of the continuous waveform modulated with the data of the ambient device. In some cases, the ambient device may send the backscattered signal to a second network device (e.g., a reader) different from the network device.

A method for wireless communication by an ambient wireless device is described. The method may include receiving an indication of a TTI structure for a slot allocated for ambient wireless device communications, the TTI structure indicating a set of multiple TTIs allocated for a set of multiple ambient wireless devices including the ambient wireless device, receiving, in a first quantity of TTIs of the set of multiple TTIs, a continuous waveform for the ambient wireless device, the first quantity of TTIs allocated for continuous waveform communications according to the TTI structure, modulating the continuous waveform with data of the ambient wireless device, and sending, in a second quantity of TTIs of the set of multiple TTIs, a backscattered signal of the continuous waveform modulated with data of the ambient wireless device, the second quantity of TTIs allocated for data from the ambient wireless device according to the TTI structure.

An ambient wireless device for wireless communication is described. The ambient wireless device may include one or more memories storing processor-executable code; and one or more processors coupled with the one or more memories and individually or collectively operable to execute the code to cause the ambient wireless device to receive an indication of a TTI structure for a slot allocated for ambient wireless device communications, the TTI structure indicating a set of multiple TTIs allocated for a set of multiple ambient wireless devices including the ambient wireless device, receive, in a first quantity of TTIs of the set of multiple TTIs, a continuous waveform for the ambient wireless device, the first quantity of TTIs allocated for continuous waveform communications according to the TTI structure, modulate the continuous waveform with data of the ambient wireless device, and send, in a second quantity of TTIs of the set of multiple TTIs, a backscattered signal of the continuous waveform modulated with data of the ambient wireless device, the second quantity of TTIs allocated for data from the ambient wireless device according to the TTI structure.

Another ambient wireless device for wireless communication is described. The ambient wireless device may include means for receiving an indication of a TTI structure for a slot allocated for ambient wireless device communications, the TTI structure indicating a set of multiple TTIs allocated for a set of multiple ambient wireless devices including the ambient wireless device, means for receiving, in a first quantity of TTIs of the set of multiple TTIs, a continuous waveform for the ambient wireless device, the first quantity of TTIs allocated for continuous waveform communications according to the TTI structure, means for modulating the continuous waveform with data of the ambient wireless device, and means for sending, in a second quantity of TTIs of the set of multiple TTIs, a backscattered signal of the continuous waveform modulated with data of the ambient wireless device, the second quantity of TTIs allocated for data from the ambient wireless device according to the TTI structure.

A non-transitory computer-readable medium storing code for wireless communication is described. The code may include instructions executable by one or more processors to receive an indication of a TTI structure for a slot allocated for ambient wireless device communications, the TTI structure indicating a set of multiple TTIs allocated for a set of multiple ambient wireless devices including the ambient wireless device, receive, in a first quantity of TTIs of the set of multiple TTIs, a continuous waveform for the ambient wireless device, the first quantity of TTIs allocated for continuous waveform communications according to the TTI structure, modulate the continuous waveform with data of the ambient wireless device, and send, in a second quantity of TTIs of the set of multiple TTIs, a backscattered signal of the continuous waveform modulated with data of the ambient wireless device, the second quantity of TTIs allocated for data from the ambient wireless device according to the TTI structure.

Some examples of the method, apparatuses, and non-transitory computer-readable medium described herein may further include operations, features, means, or instructions for receiving an indication of a frame structure for a set of slots including the slot, the frame structure indicating a respective communication direction for each slot of the set of slots, where a subset of slots of the set of slots may be allocated for the ambient wireless device communications.

In some examples of the method, apparatuses, and non-transitory computer-readable medium described herein, receiving the indication of the frame structure may include operations, features, means, or instructions for receiving the indication of the frame structure within a forward link data packet, the indication including a set of control bits of the forward link data packet, where the set of control bits further indicates a respective time duration of each slot of the set of slots, a total time duration of the set of slots, one or more frequency resources allocated for data from the ambient wireless device, or a combination thereof.

Some examples of the method, apparatuses, and non-transitory computer-readable medium described herein may further include operations, features, means, or instructions for receiving a bitmap that indicates the subset of slots, where each slot of the set of slots may be associated with a respective uplink or downlink communication direction in accordance with the frame structure.

Some examples of the method, apparatuses, and non-transitory computer-readable medium described herein may further include operations, features, means, or instructions for receiving a set of bits that indicates a pattern of time-frequency resources for the frame structure, where the pattern of time-frequency resources may be from a set of multiple patterns of time-frequency resources associated with the frame structure.

In some examples of the method, apparatuses, and non-transitory computer-readable medium described herein, receiving the indication of the TTI structure may include operations, features, means, or instructions for receiving the indication of the TTI structure that further indicates the first quantity of TTIs of the set of multiple TTIs that may be allocated for continuous wave communications, the second quantity of TTIs of the set of multiple TTIs that may be allocated for backward link data communications, and a third quantity of TTIs of the set of multiple TTIs that may be allocated for forward link data communications, the first quantity of TTIs located prior to or subsequent to the second quantity of TTIs in a time domain, where at least one TTI of the first quantity of TTIs includes a guard interval between a first TTI of the third quantity of TTIs and a second TTI of the second quantity of TTIs.

In some examples of the method, apparatuses, and non-transitory computer-readable medium described herein, receiving the indication of the TTI structure may include operations, features, means, or instructions for receiving a bitmap that indicates a pattern of symbols of the slot, the pattern of symbols indicating a subset of symbols of the slot that may be allocated for the ambient wireless device communications.

In some examples of the method, apparatuses, and non-transitory computer-readable medium described herein, receiving the indication of the TTI structure may include operations, features, means, or instructions for receiving a set of bits that indicates a pattern of time-frequency resources for the TTI structure, where the pattern of time-frequency resources may be from a set of multiple patterns of time-frequency resources associated with the TTI structure.

Some examples of the method, apparatuses, and non-transitory computer-readable medium described herein may further include operations, features, means, or instructions for receiving a second indication of a second TTI structure different from the TTI structure, the second TTI structure for a second slot allocated for the ambient wireless device communications and sending, in a third quantity of TTIs of the set of multiple TTIs, a second backscattered signal of the continuous waveform modulated with second data of the ambient wireless device, the third quantity of TTIs allocated for data from the ambient wireless device according to the second TTI structure.

In some examples of the method, apparatuses, and non-transitory computer-readable medium described herein, the TTI structure further indicates at least one TTI of the set of multiple TTIs allocated for a synchronization signal dedicated for ambient wireless device communications and the method, apparatuses, and non-transitory computer-readable medium may include further operations, features, means, or instructions for receiving, in accordance with the TTI structure, the synchronization signal in the at least one TTI of the set of multiple TTIs and synchronizing with a wireless device using the synchronization signal.

Some examples of the method, apparatuses, and non-transitory computer-readable medium described herein may further include operations, features, means, or instructions for receiving, in a third quantity of TTIs of the set of multiple TTIs, a signal indicating one or more subchannels allocated for the set of multiple ambient wireless devices, where the backscattered signal may be sent via the one or more subchannels.

Some examples of the method, apparatuses, and non-transitory computer-readable medium described herein may further include operations, features, means, or instructions for receiving, in a third quantity of TTIs of the set of multiple TTIs, a signal indicating the second TTI and a subchannel allocated for the ambient wireless device, where the backscattered signal may be sent via the subchannel.

Some examples of the method, apparatuses, and non-transitory computer-readable medium described herein may further include operations, features, means, or instructions for receiving, in a third quantity of TTIs of the set of multiple TTIs, a signal indicating a quantity of repetitions for the backscattered signal, where the backscattered signal may be sent in accordance with the quantity of repetitions.

Some examples of the method, apparatuses, and non-transitory computer-readable medium described herein may further include operations, features, means, or instructions for sending an indication of a TTI structure preference based on the data of the ambient wireless device, an energy status of the ambient wireless device, or a combination thereof.

A method for wireless communication by a first wireless device is described. The method may include receiving, from a network entity, an indication of a TTI structure for a slot allocated for ambient wireless device communications, the TTI structure indicating a set of multiple TTIs allocated for a set of multiple ambient wireless devices, transmitting, to an ambient wireless device of the set of multiple ambient wireless devices, the indication of the TTI structure, and monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

A first wireless device for wireless communication is described. The first wireless device may include one or more memories storing processor-executable code; and one or more processors coupled with the one or more memories and individually or collectively operable to execute the code to cause the first wireless device to receive, from a network entity, an indication of a TTI structure for a slot allocated for ambient wireless device communications, the TTI structure indicating a set of multiple TTIs allocated for a set of multiple ambient wireless devices, transmit, to an ambient wireless device of the set of multiple ambient wireless devices, the indication of the TTI structure, and monitor, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

Another first wireless device for wireless communication is described. The first wireless device may include means for receiving, from a network entity, an indication of a TTI structure for a slot allocated for ambient wireless device communications, the TTI structure indicating a set of multiple TTIs allocated for a set of multiple ambient wireless devices, means for transmitting, to an ambient wireless device of the set of multiple ambient wireless devices, the indication of the TTI structure, and means for monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

A non-transitory computer-readable medium storing code for wireless communication is described. The code may include instructions executable by one or more processors to receive, from a network entity, an indication of a TTI structure for a slot allocated for ambient wireless device communications, the TTI structure indicating a set of multiple TTIs allocated for a set of multiple ambient wireless devices, transmit, to an ambient wireless device of the set of multiple ambient wireless devices, the indication of the TTI structure, and monitor, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

Some examples of the method, apparatuses, and non-transitory computer-readable medium described herein may further include operations, features, means, or instructions for receiving, from the network entity, an indication of a frame structure for a set of slots including the slot, the frame structure indicating a respective communication direction for each slot of the set of slots, where a subset of slots of the set of slots may be allocated for ambient wireless device communications and transmitting, to the ambient wireless device, the indication of the frame structure for the set of slots.

Some examples of the method, apparatuses, and non-transitory computer-readable medium described herein may further include operations, features, means, or instructions for receiving a bitmap that indicates the subset of slots, where each slot of the set of slots may be associated with a respective uplink or downlink communication direction in accordance with the frame structure and transmitting the bitmap to the ambient wireless device.

Some examples of the method, apparatuses, and non-transitory computer-readable medium described herein may further include operations, features, means, or instructions for receiving a set of bits that indicates a pattern of time-frequency resources for the frame structure, where the pattern of time-frequency resources may be from a set of multiple patterns of time-frequency resources associated with the frame structure and transmitting the set of bits to the ambient wireless device.

In some examples of the method, apparatuses, and non-transitory computer-readable medium described herein, at least one slot of the set of slots is allocated for communications between the first wireless device and a second wireless device different from the first wireless device, and the method, apparatuses, and non-transitory computer-readable medium may include further operations, features, means, or instructions for transmitting, to the second wireless device in the at least one slot, a message indicating the backscattered signal of the ambient wireless device or feedback information associated with the backscattered signal.

In some examples of the method, apparatuses, and non-transitory computer-readable medium described herein, receiving the indication of the TTI structure may include operations, features, means, or instructions for receiving a set of bits that indicates a pattern of time-frequency resources for the TTI structure, where the pattern of time-frequency resources may be from a set of multiple patterns of time-frequency resources associated with the TTI structure and transmitting the set of bits to the ambient wireless device.

In some examples of the method, apparatuses, and non-transitory computer-readable medium described herein, receiving the indication of the TTI structure may include operations, features, means, or instructions for receiving the indication of the TTI structure that further indicates the first quantity of TTIs of the set of multiple TTIs that may be allocated for backward link communications, a second quantity of TTIs of the set of multiple TTIs that may be allocated for forward link data communications, and a third quantity of TTIs of the set of multiple TTIs that may be allocated for continuous waveform communications, the third quantity of TTIs located prior to or subsequent to the first quantity of TTIs in a time domain, where at least one TTI of the third quantity of TTIs includes a guard interval between a first TTI of the first quantity of TTIs and a second TTI of the second quantity of TTIs.

Some examples of the method, apparatuses, and non-transitory computer-readable medium described herein may further include operations, features, means, or instructions for receiving a second indication of a second TTI structure different from the TTI structure, the second TTI structure for a second slot allocated for the ambient wireless device communications, transmitting, to the ambient wireless device, the second indication of the second TTI structure, and receiving, from the ambient wireless device in a third quantity of TTIs of the set of multiple TTIs, a second backscattered signal of the continuous waveform modulated with second data of the ambient wireless device, the third quantity of TTIs allocated for data from the ambient wireless device according to the second TTI structure.

Some examples of the method, apparatuses, and non-transitory computer-readable medium described herein may further include operations, features, means, or instructions for transmitting, to a second wireless device, the indication of the TTI structure and receiving, from the second wireless device, an indication of a second TTI structure different from the TTI structure, the second TTI structure associated with the second wireless device and a second set of multiple ambient devices.

Some examples of the method, apparatuses, and non-transitory computer-readable medium described herein may further include operations, features, means, or instructions for modifying the TTI structure based on the indication of the second TTI structure, a relative distance between the first wireless device and the second wireless device, or a combination thereof.

In some examples of the method, apparatuses, and non-transitory computer-readable medium described herein, the TTI structure further indicates at least one TTI of the set of multiple TTIs allocated for a synchronization signal dedicated for ambient wireless device communications and the method, apparatuses, and non-transitory computer-readable medium may include further operations, features, means, or instructions for receiving, from a second wireless device in accordance with the TTI structure, the synchronization signal in the at least one TTI of the set of multiple TTIs and synchronizing with the second wireless device using the synchronization signal.

Some examples of the method, apparatuses, and non-transitory computer-readable medium described herein may further include operations, features, means, or instructions for receiving, from the ambient wireless device, an indication of a TTI structure preference based on the data of the ambient wireless device, an energy status of the ambient wireless device, or a combination thereof.

A method for wireless communication by a second wireless device is described. The method may include receiving, from a network entity, an indication of a TTI structure for a slot allocated for ambient wireless device communications, the TTI structure indicating a set of multiple TTIs allocated for a set of multiple ambient wireless devices, transmitting, to an ambient wireless device of the set of multiple ambient wireless devices, the indication of the TTI structure, and transmitting, in a first quantity of TTIs of the set of multiple TTIs, a continuous waveform for activation of the ambient wireless device, the first quantity of TTIs allocated for the continuous waveform according to the TTI structure.

A second wireless device for wireless communication is described. The second wireless device may include one or more memories storing processor-executable code; and one or more processors coupled with the one or more memories and individually or collectively operable to execute the code to cause the second wireless device to receive, from a network entity, an indication of a TTI structure for a slot allocated for ambient wireless device communications, the TTI structure indicating a set of multiple TTIs allocated for a set of multiple ambient wireless devices, transmit, to an ambient wireless device of the set of multiple ambient wireless devices, the indication of the TTI structure, and transmit, in a first quantity of TTIs of the set of multiple TTIs, a continuous waveform for activation of the ambient wireless device, the first quantity of TTIs allocated for the continuous waveform according to the TTI structure.

Another second wireless device for wireless communication is described. The second wireless device may include means for receiving, from a network entity, an indication of a TTI structure for a slot allocated for ambient wireless device communications, the TTI structure indicating a set of multiple TTIs allocated for a set of multiple ambient wireless devices, means for transmitting, to an ambient wireless device of the set of multiple ambient wireless devices, the indication of the TTI structure, and means for transmitting, in a first quantity of TTIs of the set of multiple TTIs, a continuous waveform for activation of the ambient wireless device, the first quantity of TTIs allocated for the continuous waveform according to the TTI structure.

A non-transitory computer-readable medium storing code for wireless communication is described. The code may include instructions executable by one or more processors to receive, from a network entity, an indication of a TTI structure for a slot allocated for ambient wireless device communications, the TTI structure indicating a set of multiple TTIs allocated for a set of multiple ambient wireless devices, transmit, to an ambient wireless device of the set of multiple ambient wireless devices, the indication of the TTI structure, and transmit, in a first quantity of TTIs of the set of multiple TTIs, a continuous waveform for activation of the ambient wireless device, the first quantity of TTIs allocated for the continuous waveform according to the TTI structure.

Some examples of the method, apparatuses, and non-transitory computer-readable medium described herein may further include operations, features, means, or instructions for receiving, from the network entity, an indication of a frame structure for a set of slots including the slot, the frame structure indicating a respective communication direction for each slot of the set of slots, where a subset of slots of the set of slots may be allocated for ambient wireless device communications and transmitting, to the ambient wireless device, the indication of the frame structure for the set of slots.

Some examples of the method, apparatuses, and non-transitory computer-readable medium described herein may further include operations, features, means, or instructions for receiving a bitmap that indicates the subset of slots, where each slot of the set of slots may be associated with a respective uplink or downlink communication direction in accordance with the frame structure.

Some examples of the method, apparatuses, and non-transitory computer-readable medium described herein may further include operations, features, means, or instructions for receiving a set of bits that indicates a pattern of time-frequency resources for the frame structure, where the pattern of time-frequency resources may be from a set of multiple patterns of time-frequency resources associated with the frame structure.

In some examples of the method, apparatuses, and non-transitory computer-readable medium described herein, at least one slot of the set of slots is allocated for communications between the second wireless device and a first wireless device different from the second wireless device, and the method, apparatuses, and non-transitory computer-readable medium may include further operations, features, means, or instructions for receiving, from the first wireless device in the at least one slot, a message indicating a backscattered signal of the ambient wireless device or feedback information associated with the backscattered signal.

In some examples of the method, apparatuses, and non-transitory computer-readable medium described herein, receiving the indication of the TTI structure may include operations, features, means, or instructions for receiving the indication of the TTI structure that further indicates the first quantity of TTIs of the set of multiple TTIs that may be allocated for continuous wave communications, a second quantity of TTIs of the set of multiple TTIs that may be allocated for forward link data communications, and a third quantity of TTIs of the set of multiple TTIs that may be allocated for backward link data communications, where at least one TTI of the first quantity of TTIs includes a guard interval between a first TTI of the third quantity of TTIs and a second TTI of the second quantity of TTIs.

In some examples of the method, apparatuses, and non-transitory computer-readable medium described herein, receiving the indication of the TTI structure may include operations, features, means, or instructions for receiving a set of bits that indicates a pattern of time-frequency resources for the TTI structure, where the pattern of time-frequency resources may be from a set of multiple patterns of time-frequency resources associated with the TTI structure.

Some examples of the method, apparatuses, and non-transitory computer-readable medium described herein may further include operations, features, means, or instructions for receiving a second indication of a second TTI structure different from the TTI structure, the second TTI structure for a second slot allocated for ambient wireless device communications and transmitting, to the ambient wireless device, the second indication of the second TTI structure.

Some examples of the method, apparatuses, and non-transitory computer-readable medium described herein may further include operations, features, means, or instructions for transmitting, to a first wireless device, an indication of the TTI structure and receiving, from the first wireless device, an indication of a second TTI structure different from the TTI structure, the second TTI structure associated with the first wireless device and a second set of multiple ambient devices.

Some examples of the method, apparatuses, and non-transitory computer-readable medium described herein may further include operations, features, means, or instructions for modifying the TTI structure based on the indication of the second TTI structure, a relative distance between the first wireless device and the second wireless device, or a combination thereof.

In some examples of the method, apparatuses, and non-transitory computer-readable medium described herein, the TTI structure further indicates at least one TTI of the set of multiple TTIs allocated for a synchronization signal dedicated for ambient wireless device communications and the method, apparatuses, and non-transitory computer-readable medium may include further operations, features, means, or instructions for transmitting, to a first wireless device in accordance with the TTI structure, the synchronization signal in the at least one TTI of the set of multiple TTIs and synchronizing with the first wireless device using the synchronization signal.

In some examples of the method, apparatuses, and non-transitory computer-readable medium described herein, the TTI structure indicates a second quantity of TTIs of the set of multiple TTIs allocated for a backscattered signal from the ambient wireless device and the method, apparatuses, and non-transitory computer-readable medium may include further operations, features, means, or instructions for transmitting, to the ambient wireless device in a third quantity of TTIs of the set of multiple TTIs, a signal indicating one or more subchannels allocated for the set of multiple ambient wireless devices.

In some examples of the method, apparatuses, and non-transitory computer-readable medium described herein, the TTI structure indicates a second quantity of TTIs of the set of multiple TTIs allocated for a backscattered signal from the ambient wireless device and the method, apparatuses, and non-transitory computer-readable medium may include further operations, features, means, or instructions for transmitting, to the ambient wireless device in a third quantity of TTIs of the set of multiple TTIs, a signal indicating a quantity of repetitions for the backscattered signal.

### BRIEF DESCRIPTION OF THE DRAWINGS

FIGS. 1 and 2 show examples of wireless communication systems that support a TTI structure for ambient wireless device communications in accordance with one or more aspects of the present disclosure.

FIG. 3 shows an example of a frame structure that supports a TTI structure for ambient wireless device communications in accordance with one or more aspects of the present disclosure.

FIGS. 4-5 show examples of TTI structures that support a TTI structure for ambient wireless device communications in accordance with one or more aspects of the present disclosure.

FIG. 6 shows an example of a process flow that supports TTI structure for ambient wireless device communications in accordance with one or more aspects of the present disclosure.

FIGS. 7 and 8 show block diagrams of devices that support TTI structure for ambient wireless device communications in accordance with one or more aspects of the present disclosure.

FIG. 9 shows a block diagram of a communications manager that supports TTI structure for ambient wireless device communications in accordance with one or more aspects of the present disclosure.

FIG. 10 shows a diagram of a system including a device that supports TTI structure for ambient wireless device communications in accordance with one or more aspects of the present disclosure.

FIGS. 11 and 12 show block diagrams of devices that support TTI structure for ambient wireless device communications in accordance with one or more aspects of the present disclosure.

FIG. 13 shows a block diagram of a communications manager that supports TTI structure for ambient wireless device communications in accordance with one or more aspects of the present disclosure.

FIG. 14 shows a diagram of a system including a device that supports TTI structure for ambient wireless device communications in accordance with one or more aspects of the present disclosure.

FIGS. 15 through 20 show flowcharts illustrating methods that support TTI structure for ambient wireless device communications in accordance with one or more aspects of the present disclosure.

### DETAILED DESCRIPTION

In some examples of wireless communications, a wireless network device, such as a user equipment (UE), a network entity, or the like, may communicate with an ambient wireless device (e.g., a radio frequency identification (RFID) tag, an ambient internet-of-things (IoT) device, a zero-power IoT (ZP-IoT) device, among other examples). In some examples, the network device may transmit a continuous waveform to the ambient wireless device. A continuous waveform may be an electromagnetic wave of constant amplitude and frequency (e.g., a sine wave). Additionally, or alternatively, the network device may transmit a query (e.g., forward link (FL) data or commands) to the ambient wireless device. The ambient wireless device may use the continuous waveform to send, via a backward link (BL), a backscattered signal to the network device. A backscattered signal may be a reflection of the continuous waveform that the ambient wireless device sends back in the direction of the network device. In some examples, the ambient wireless device may include additional information (e.g., a set of data bits) in the backscattered signal. For example, the ambient wireless device may modulate the continuous waveform with the set of data bits and reflect the modulated continuous waveform back to the network device as a backscattered signal.

In some scenarios, the network device may communicate with multiple ambient wireless devices. For example, the network device may broadcast a query to multiple ambient wireless devices simultaneously, and may provide a continuous waveform to the multiple ambient wireless devices for use in backscattered signaling. Due to relatively reduced complexity of ambient wireless devices, however, the ambient wireless devices may be restricted to relatively simpler communication schemes than the network device. For example, an ambient wireless device may be unable to receive signals based on frequency selectivity. Thus, the network device may rely on time-domain multiplexing (TDM) techniques to communicate with the ambient wireless devices, which may be associated with relatively low spectral efficiency. Further, ambient wireless devices may not be configured to perform sensing, resource selection, or other procedures that support coordinated communications across multiple devices. Without such procedures, ambient wireless devices may be incapable of organized communications with a network device. For example, if responses from the multiple ambient wireless devices are not aligned with one another (e.g., in a time domain, in a frequency domain, or both), resource utilization efficiency may be significantly degraded and the likelihood of collisions between backscattered signals may increase.

Accordingly, aspects of the present disclose are directed to resource configurations that support efficient communications between ambient wireless devices and other network devices (e.g., wireless devices that are connected to a network). A network device (e.g., a UE, a network entity) may configure a transmission time interval (TTI) structure that includes resources (e.g., time domain resources, frequency domain resources) designated for communications to or from an ambient wireless device. For example, the TTI structure may include one or more TTIs (e.g., one or more symbol periods, one or more slots, one or more mini-slots, or the like) allocated for uplink communications, one or more TTIs allocated for downlink communications, and one or more TTIs allocated for ambient wireless device communications. Each TTI of the one or more TTIs may have a respective time duration, which may differ between TTIs. In some aspects, the TTI structure may include or be an example of a frame structure. In some cases, one or more subchannels associated with the one or more TTIs may be allocated for the ambient wireless device communications. Additionally, or alternatively, the TTI structure may indicate one or more TTIs configured for communicating a continuous waveform, FL data, a BL signal, or a combination thereof.

The network device may transmit an indication of the TTI structure to one or more ambient wireless devices, e.g., in addition to a continuous waveform. A receiving ambient wireless device may modulate the continuous waveform with data for a backscattered signal. The ambient wireless device may send the backscattered signal to the network device in a TTI of the TTI structure that is allocated for data from the ambient wireless device. In some cases, the network device may receive backscattered signals from multiple ambient wireless devices, where each ambient wireless device sends a backscattered signal in a respective TTI according to the TTI structure. The respective TTIs may overlap. For example, the ambient wireless devices may each send a respective backscattered signal in a same TTI, but via respective subchannels. Thus, the network device may efficiently and reliably simultaneously communicate with multiple ambient wireless devices.

Particular aspects of the subject matter described herein may be implemented to realize one or more advantages. The described techniques may support reduced power consumption at ambient wireless devices and network devices. For example, a network device may expect a backscattered signal at a time resource indicated by a TTI structure. Thus, rather than continuously monitoring for the backscattered signal, the network device may only perform monitoring at the indicated time resource. Further, the TTI structure may provide a mechanism for organizing communications between multiple ambient devices, which may enable a network device to communicate with more than one ambient wireless device at a time. For example, each ambient wireless devices may be allocated a respective subchannel and a same TTI, such that the network device receives multiple backscattered signals from respective ambient devices in the same TTI. Such simultaneous communications may reduce delays and improve efficiency in resource utilization. As such, supported techniques may promote device and network efficiencies, among other benefits.

Aspects of the disclosure are initially described in the context of wireless communications systems. Aspects of the disclosure are then discussed with reference to resource configurations and a process flow. Aspects of the disclosure are further illustrated by and described with reference to apparatus diagrams, system diagrams, and flowcharts that relate to transmission time interval structure for ambient wireless device communications.

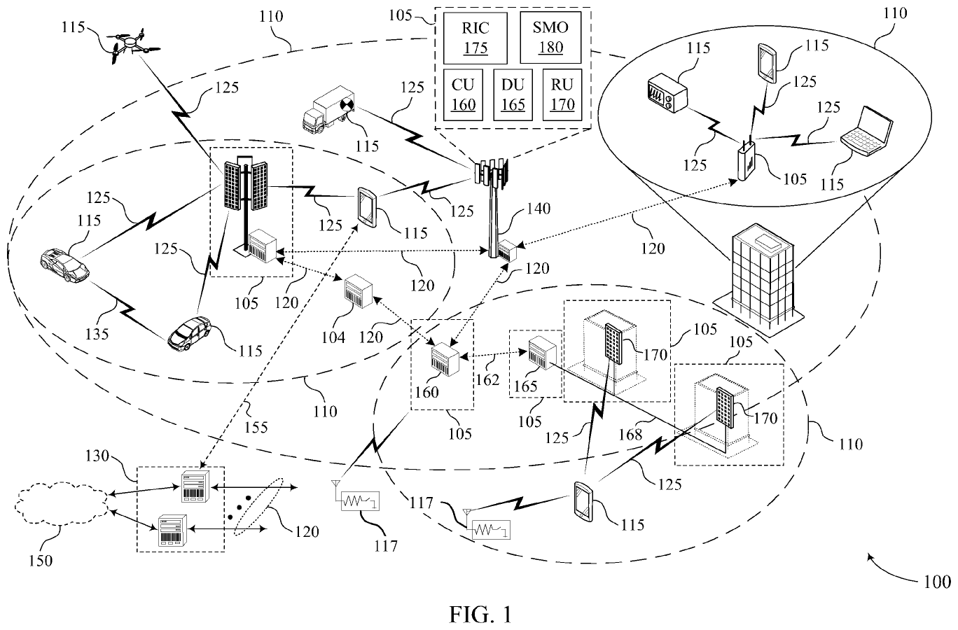

FIG. 1 shows an example of a wireless communications system 100 that supports TTI structure for ambient wireless device communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUS 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol).

Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support TTI structure for ambient wireless device communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported subcarrier spacing, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a TTI (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1: M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUS 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some implementations, the wireless communications system 100 may include one or more relatively low-power wireless devices, such as ambient devices 117. Ambient devices 117 may include, but are not limited to, RFID tags, IoT devices, ZP IoT device, hybrid devices including passive and active components, components of otherwise active/querying devices (e.g., passive components of a UE 115), or any combination thereof. Ambient devices 117 may rely passive communication technologies, such as energy harvesting and backscatter communications, in order to operate using relatively low power and at relatively low cost. For example, in some cases, a UE 115 of the wireless communications system 100 may serve as an ambient device 117. A network device (e.g., an NR device, such as a network entity 105 or a UE 115) communicating with an ambient device 117 may be referred to as a reader device or a querying device.

An ambient device 117 be capable of using energy (e.g., electromagnetic energy) from a received radio frequency (RF) signal to perform operations at the device, which may be referred to as energy harvesting (EH). For example, an ambient device 117 may receive a radio frequency (RF) signal and may use energy from the RF signal to charge a battery at the device or otherwise provide power for performing one or more operations (e.g., data decoding, data encoding, filtering operations, data transmission, data reception) at the ambient device 117. In some examples, ambient devices 117 may rely on distributed nodes of the wireless communications system 100, such as the UEs 115 or the network entities 105, to extend or enlarge coverage areas. Distributed nodes may provide a more powerful and flexible network for the ambient devices 117 implementing backscatter communications. Moreover, an ambient device 117 may harvest energy from ambient sources, such as RF signals communicated between other devices or nodes of the wireless communications system 100 (e.g., RF signals that are not sent directly to the ambient device 117). Such implementations may be referred to as ambient backscatter or ambient power-enabled IoT.

A network device that transmits an RF signal to an ambient device 117 may be referred to as an RF source. The RF signal may include or be an example of a continuous (i.e., unmodulated) waveform to power up the ambient device 117, to provide a carrier wave for the ambient device 117, or the like. Additionally, or alternatively, the RF signal may be a modulated waveform that includes data for the ambient device 117, such as a query, one or more commands, feedback information, or the like. A directional communication link from the network device to the ambient device 117 may be referred to as a forward link (FL), while a directional communication link from the ambient device 117 to the network device may be referred to as a backward link (BL) or a backscattered link.

The ambient device 117 may use the received RF signal to activate or otherwise power up one or more components for communicating with the wireless device. In some cases, the ambient device 117 may modulate the RF signal with a set of data bits. The ambient device 117 may reflect the modulated RF signal back to the wireless device as a backscattered signal. In some implementations, the ambient device 117 may have one or more active components and may be capable of active transmission of the backscattered signal (e.g., instead of reflecting the backscattered signal).

In some cases, the network device that transmits an RF signal to the ambient device 117 via a FL may be different from a network device to which the ambient device 117 sends the backscattered signal via a BL. Such scenarios may be referred to as bistatic communications. The network device transmitting the RF signal to the ambient device 117 may be referred to as an RF source, while the network device receiving the backscattered signal may be referred to as a reader. In contrast, monostatic communications may refer to scenarios in which transmission of the RF signal and reception of the backscattered signal occur at a same network device. Here, the network device may be understood as being both a reader and an RF source, but may be referred to as a reader. In monostatic communications, one or more time gaps may be configured to support switching between transmission and reception modes at the reader. For example, a time gap T1 may span a duration between an end of a transmission from the reader (e.g., a query) and a beginning of a backscattered signal sent from the ambient device 117. A time gap T2 may span a duration between an end of the backscattered signal sent from the ambient device 117 and a beginning of a transmission from the reader (e.g., a feedback message).

In scenarios with multiple ambient devices 117, RF sources, and readers, significant latency may be introduced if communications from respective devices are not aligned with one another. For example, a network device may rely on TDM techniques to communicate with each ambient device 117 of a group of ambient devices 117. In such cases, the network device may only be able to communicate with a single ambient device 117 at a time, which may introduce significant latency and reduce efficiency in resource utilization. Additionally, or alternatively, the network device may be unable to respond to some or all of the ambient devices 117 in a prompt manner. Further, the ambient devices 117 may not be configured with (e.g., allocated) specific resources (e.g., time resources, frequency resources) for sending respective backscattered signals. Thus, the ambient devices 117 may send backscattered signals that overlap with one another, which may cause interference and degrade performance and reliability.

The techniques and methods described herein support more efficient use of resources for communications with ambient devices 117, which may, in turn, reduce latency and improve reliability of such communications. For example, a network device, such as a UE 115 or a network entity 105, may configure a TTI structure to include one or more TTIs (e.g., one or more symbol periods, one or more slots, one or more mini-slots, or the like) for uplink communications, one or more TTIs for downlink communications, and one or more TTIs for ambient wireless device communications. Additionally, or alternatively, the TTI structure may indicate one or more TTIs configured for respective communication types, such as continuous waveforms, FL data, BL signals, or a combination thereof. Each TTI of the TTI structure may have a respective time duration, which may differ between TTIs and may vary over time. In some cases, a TTI may have a time duration equivalent to an NR slot. Additionally, or alternatively, the TTI structure may have a total time duration that is equivalent to an NR frame, e.g., may include ten (10) subframes, where each subframe includes two (2) NR slots.

The network device may indicate the TTI structure to one or more ambient devices 117. In some cases, the network device may additionally or alternatively indicate the TTI structure to a second network device. For instance, in bistatic communications, the network device may be an RF source that indicates the TTI structure to a reader, or the network device may be a reader that indicates the TTI structure to an RF source. As another example, the network device may be an example of a network entity 105 that indicates the TTI structure to a UE 115, and the UE 115 may communicate with the one or more ambient devices 117 according to the TTI structure.

An ambient device 117 receiving the TTI structure may communicate with the network device and, in some cases, one or more other network devices, in accordance with the TTI structure. For example, the ambient device 117 may modulate the continuous waveform with data for a backscattered signal. The ambient device 117 may send the backscattered signal to the network device in a TTI of the TTI structure that is allocated for data from the ambient device 117. In some cases, the network device may receive backscattered signals from multiple ambient devices 117, where each ambient device 117 sends a backscattered signal in a respective TTI according to the TTI structure. Thus, the network device may simultaneously communicate with multiple ambient devices 117.

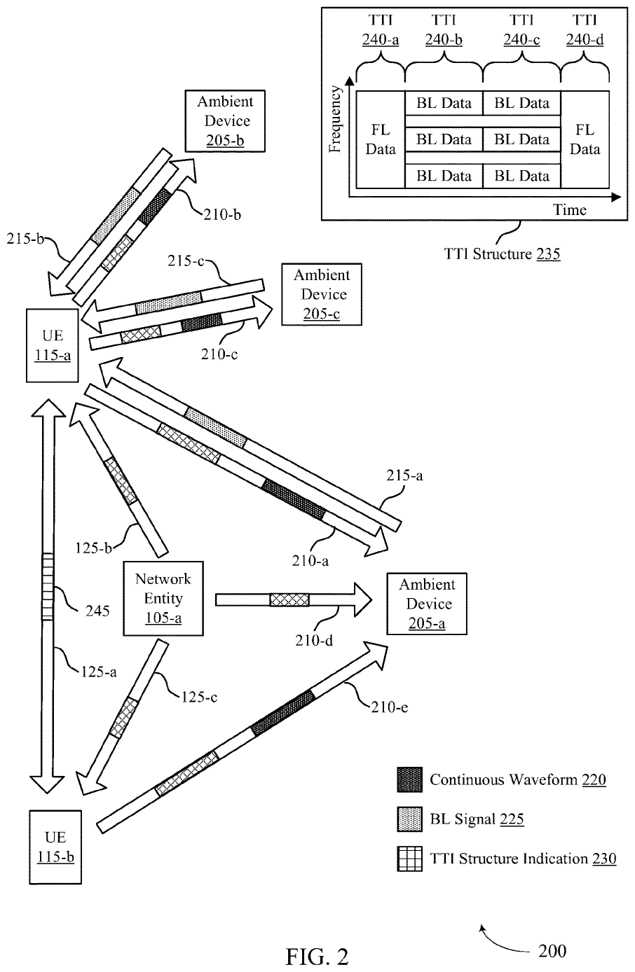

FIG. 2 shows an example of a wireless communications system 200 that supports a TTI structure for ambient wireless device communications in accordance with one or more aspects of the present disclosure. In some examples, aspects of the wireless communications system 200 may implement, or be implemented by, aspects of the wireless communications system 100. For example, the wireless communications system 200 may include a network entity 105-a, a UE 115-a, and a UE 115-b, which may be examples of corresponding devices as described with reference to FIG. 1. The wireless communications system 200 may further include an ambient device 205-a, an ambient device 205-b, and an ambient device 205-c, which may include or be examples of ambient wireless devices as described herein.

In the wireless communications system 200, the network entity 105-a, the UE 115-a, and the UE 115-b may each be respective examples of (e.g., may operate as) a network device communicating with one or more ambient devices 205. Additionally, the UE 115-a and the UE 115-b may communicate with each other via a communication link 125-a, while the network entity 105-a may communicate with the UE 115-a via a communication link 125-b and with the UE 115-b via a communication link 125-c. The communication links 125 may include or be examples of sidelink communication links, uplink communication links, downlink communication links, or the like, among other examples.

In some examples, each of the UE 115-a, the UE 115-b, and the network entity 105-a may operate as a reader, an RF source, or a reader and an RF source. For example, in bistatic communications, an ambient device 205 may receive an RF signal from a first network device (e.g., the UE 115-a, the UE 115-b, or the network entity 105-a) and may send a backscattered signal to a second network device (e.g., the UE 115-a, the UE 115-b, or the network entity 105-a) different from the first network device. Here, the first network device may be considered an RF source, which may be defined as a network device that transmits signals (e.g., data signals, continuous waveforms) via an FL 210 to an ambient device 205. The second network device may be considered a reader, which may be defined as a network device that receives signals via a BL 215 from an ambient device 205.

Additionally, or alternatively, one or more of the UE 115-a, the UE 115-b, and the network entity 105-a may implement monostatic communications with an ambient device 205, where a network device (e.g., the UE 115-a, the UE 115-b, or the network entity 105-a) transmits signals to an ambient device via an FL 210 and receives signals from the ambient device 205 via a BL 215. In such examples, the network device may be understood as being both a reader and an RF source, but may be referred to as a reader, a querying device, or the like. It is to be understood that FIG. 2 illustrates an example implementation of the techniques described herein and is not to be construed as limiting. For example, the UEs 115 and the network entity 105 may operate as any combination of RF sources, readers, or both, and may each communicate with any quantity of ambient devices 205, e.g., according to monostatic communications, bistatic communications, or both.

As it is used herein, the term “ambient device” may be used to refer to devices which may utilize passive signaling for performance of transmissions by the ambient device 205, actively powered radio signals for performance of transmissions by the ambient device 205, or both. In this regard, the ambient device 205 may receive power from RF signals received from other devices (e.g., via energy harvesting), from power sources associated with the ambient device 205, or both. Moreover, as it is used herein, the terms “querying device,” “reader,” “reader device,” “RF source,” “network device,” or any combination thereof, may refer to wireless devices (e.g., UEs 115, network entities 105, IAB nodes) that are configured to communicate with an ambient device 205, such as by transmitting signals (e.g., queries, commands) to the ambient device 205 and/or receiving/reading signals from the ambient device 205.

In some aspects, each ambient device 205 may include or be an example of a lower-complexity device (e.g., <100 μW device), such as an RFID tag, a passive IoT device, a ZP IoT device, a hybrid device including passive and active components (e.g., a semi-passive tag, a semi-active tag), or a passive component of a querying/active device (e.g., a passive component of a UE 115). For example, an ambient device 205 may include or be an example of a battery-less or a limited energy storage (e.g., capacitor) device capable of wireless communication, such as an RFID tag. An ambient device 205 may be used to support various services and applications within the wireless communications system 200, such as identification or tracking. Other use cases that may be supported or facilitated by the ambient device 205 may include power sourcing, security applications, access control or access connectivity management, and positioning services. Additionally, the ambient device 205 may be capable of communicating over different frequency ranges, such as UHF ranges. For instance, the ambient device 205 may include or be an example of a UHF RFID tag.

Each ambient device 205 of the wireless communications system 200 may be configured to perform various types of operations, including writing operations and reading operations. A writing operation may include one-way signaling from a querying device (e.g., the network entity 105-a, a UE 115) to an ambient device 205 to configure or adjust parameters of the ambient device 205. For example, writing operations may be used to change some information at an ambient device 205 or adjust parameters or characteristics at an ambient device 205, such as an identifier associated with the ambient device 205 or a type or frequency of measurements performed by the ambient device 205.

Comparatively, a reading operation may include two-way signaling between a querying device and an ambient device 205 in which the querying device transmits a query or message, and receives or “reads” some responsive signaling back from the ambient device 205. For example, in the context of a reading operation, the UE 115-a may transmit a query to an ambient device 205 to request some information from the ambient device 205, and the ambient device 205 may return information or data in response to the query, such as data, a type of control information, measurements performed by the ambient device 205, a location of the ambient device 205, sensed information, or any combination thereof.

As noted herein, in some implementations, each ambient device 205 may include or be an example of a relatively low-complexity device which may or may not include a power amplifier and/or a battery. In some cases, an ambient device 205 may include antennas (e.g., dipole antennas) and other circuitry (e.g., integrated circuit, chip, load) and components (e.g., rectifier, modulator, demodulator) used to facilitate wireless communications. In some aspects, the range over which the ambient device 205 can transmit a message (e.g., a backscattered signal) may depend on the manner in which the ambient device 205 is powered. For example, in some cases, the ambient device 205 may not include a power source and may be referred to as a ZP IoT device. The ambient device 205 may instead support energy harvesting, in which the ambient device 205 converts power absorbed from received signals or ambient sources. The ambient device 205 may use the converted power to modulate and/or transmit a wave or message, for instance, as a response to a received command.

In some aspects, the ambient device 205 may receive or generate power used for wireless communications and other operations using a rectifier, where a rectifier may include a diode and a capacitor. For example, the ambient device 205 may receive a signal from a querying device via an antenna, where power absorbed from the antenna is directed to a power rectifier. The signal may be an example of a continuous wave (CW) or an NR signal. In this example, the power rectifier converts absorbed power from the antenna to rectified power, which may be directed back to the antenna to transmit messages (e.g., transmit backscattered signals).

For example, an ambient device 205 may include a modulated retro reflector (MRR), which may allow the ambient device 205 to reflect and modulate received optical beams. The MRR may include a modulator and a reflector. The ambient device 205 may receive an optical beam from an RF source, such as the UE 115-a, and may change the direction of the optical beam using the reflector. The ambient device 205 may reflect the optical beam in a same or similar direction in which the optical beam was received. The reflected optical beam may pass through the modulator and the modulated optical beam may continue in the direction dictated by the reflector. In such examples, the modulated optical beam may be an example of a backscattered signal.

A network device, such as the UE 115-a, may implement TDM for communicating with multiple ambient devices 205. For example, the UE 115-a may communicate with the ambient device 205-a in a first time interval and may communicate with the ambient device 205-b in a second time interval subsequent to the first time interval. Additionally, the ambient devices 205 may each respond to the UE 115-a in arbitrary (e.g., random) resources. Such scenarios may be associated with relatively high latency and relatively poor efficiency in resource utilization, as the UE 115-a may only communicate with a single ambient device 205 in a given time interval. Moreover, the UE 115-a may receive responses from each ambient device 205 at arbitrary times, which increases the likelihood of interference and reduces reliability.

Thus, the techniques described herein provide constraints for resources in which ambient devices 205 may communicate, which may support simultaneous communication between a network device and a group of ambient devices 205. For example, the UE 115-a and the ambient devices 205 may communicate according to a pattern (e.g., format) of resources (e.g., time domain resources, frequency domain resources). The pattern may include ambient device communication occasions, e.g., occasions in which an ambient device 205 may send or receive one or more signals. For example, a TTI structure 235 may be defined that includes a group of TTIs 240 allocated for the ambient device communications. A first TTI 240-a and a fourth TTI 240-d may be allocated (e.g., designated, assigned) for FL communications (e.g., FL data, commands, queries, continuous waveforms 220), for example, from the UE 115-a to the group of ambient devices 205. A second TTI 240-b and a third TTI 240-c may be allocated for BL communications (e.g., BL data). A network device (e.g., an RF source, a reader, a UE 115, a network entity 105) may configure the TTI structure 235 and may transmit a TTI structure indication 230 to one or more ambient devices.

For example, the UE 115-a and one or more ambient devices 205, such as the ambient device 205-a, may communicate according to bistatic communications, where the UE 115-a operates as a reader and another device, such as the network entity 105-a, the UE 115-b, or both, operates as an RF source. For example, the network entity 105-a and the UE 115-b may communicate with the ambient device 205-a via an FL 210-d and an FL 210-e, respectively, while the UE 115-a communicates with the ambient device 205-a via a BL 215-a. In such examples, the UE 115-a may not transmit FL data to the ambient device (e.g., via an FL 210-a).

Additionally, or alternatively, the UE 115-a may implement monostatic communications and may operate as an RF source that transmits FL signals to the ambient devices 205 (e.g., via respective FLs 210) and as a reader that receives BL signals 225 from the ambient devices 205. For example, the UE 115-a may communicate with the group of ambient devices 205. The UE 115-a may communicate with the ambient device 205-a via an FL 210-a and a BL 215-a, with the ambient device 205-b via an FL 210-b and a BL 215-b, and with the ambient device 205-c via an FL 210-c and a BL 215-c.

The UE 115-a may transmit, to the ambient devices 205, a continuous waveform 220, which may be an example of an unmodulated signal that provides a BL 215 (e.g., between an ambient device 205 and the UE 115-a) and can be used for activation of an ambient device 205. Additionally, or alternatively, the UE 115-a may transmit one or more commands, such as a query, to the ambient devices 205. In some cases, the UE 115-a may broadcast the query to the group of ambient devices 205 over a relatively wide bandwidth, and may broadcast the continuous waveform 220 to the group of ambient devices 205 over a relatively narrow bandwidth.

Additionally, the UE 115-a may transmit (e.g., broadcast), to the ambient devices 205, a message indicating the TTI structure 235. For example, the UE 115-a may transmit a TTI structure indication 230, which may include or be an example of a set of control bits or a bitmap that indicates a pattern of TTIs 240. The UE 115-a may configure (e.g., dynamically, statically, semi-statically) the TTI structure 235 and may transmit the TTI structure indication 230 to the ambient devices 205, e.g., via L1 signaling, L2 signaling, L3 signaling, or some combination thereof. Each TTI 240 may be associated with a respective communication direction. In some cases, the TTI structure 235 may correspond to a slot (e.g., an NR slot) allocated for ambient device communications, where each TTI 240 corresponds to a symbol within the slot.

Additionally, or alternatively, the TTI structure 235 may correspond to a portion of a frame (e.g., an NR frame), where each TTI 240 corresponds to a slot within the frame. In such cases, the TTIs 240 may be allocated for the ambient device communications and the frame may include additional TTIs that are allocated for uplink communications, downlink communications, or both.

Each ambient device 205 may harvest energy from the received continuous waveform 220 and use the energy to power up one or more components, e.g., to perform one or more operations at the ambient device 205 based on receiving the query. An ambient device 205 may, for example, modulate the continuous waveform 220 with data of the ambient device 205 to obtain a backscattered signal, such as a BL signal 225. Each ambient device 205 may send (e.g., reflect, actively transmit) the BL signal 225 to the UE 115-a via a corresponding BL 215 in accordance with the TTI structure 235, e.g., using resources allocated for the ambient devices 205 as indicated by the TTI structure 235.

In some cases, the TTI structure 235 may allocate resources for the group of ambient devices 205. For example, the TTI structure 235 may indicate that the TTI 240-b and the TTI 240-c are allocated for the ambient device communications, and each of the ambient devices 205 may send the respective BL signal 225 in either (or both) of the TTI 240-b and the TTI 240-c. Additionally, or alternatively, the TTI structure 235 may allocate resources on a per-ambient device 205 basis. Here, the TTI structure 235 may indicate a respective one or more TTIs 240 assigned to each ambient device 205. For example, the TTI structure 235 may indicate that the TTI 240-b is allocated to the ambient device 205-b and the ambient device 205-c, while the TTI 240-c is allocated to the ambient device 205-a.

Additionally, in some examples, one or more frequency domain resources (e.g., as one or more subchannels), may be allocated for the ambient device communications, and may be indicated to the ambient devices 205 (e.g., as part of the TTI structure indication 230 or separately from the TTI structure indication 230). For instance, a group of subchannels (e.g., of a carrier) may be designated for the ambient device communications, and each ambient device 205 may utilize any subchannel from the group of subchannels for a BL signal 225. In another example, each ambient device 205 may be allocated a respective subchannel of the group of subchannels.

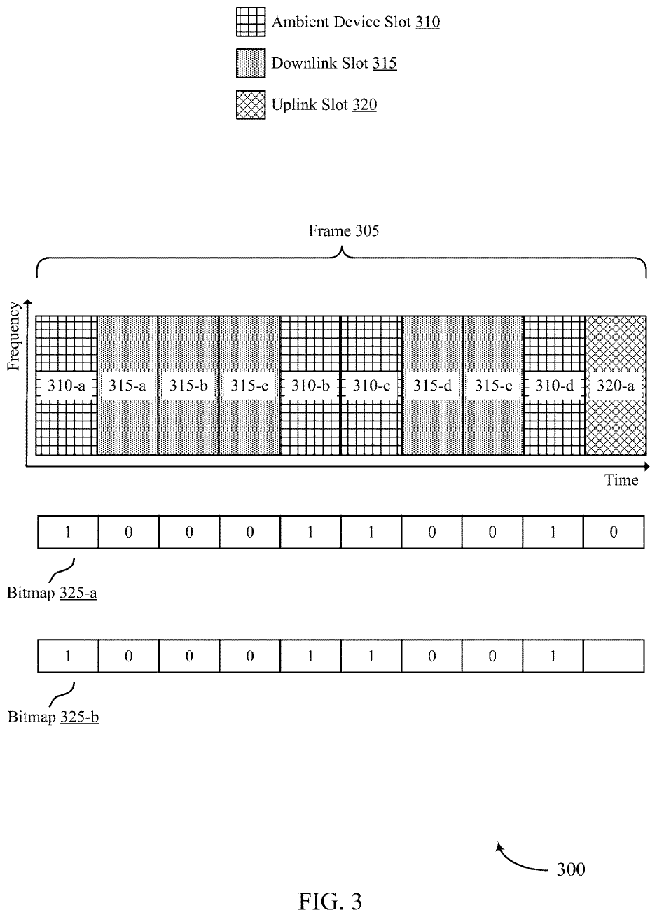

As discussed with reference to FIGS. 3-5, a network device may configure the TTI structure 235 based on a respective communication direction associated with each TTI 240 or a device type of an RF source of the ambient device communications, among other examples. An ambient device 205 may be configured (e.g., dynamically, statically, semi-statically) with the TTI structure 235 by an RF source or a reader, such as the UE 115-a. Additionally, or alternatively, a network entity 105, such as the network entity 105-a, may configure (e.g., dynamically, statically, semi-statically) the TTI structure 235 and may indicate the TTI structure 235 (e.g., may transmit the TTI structure indication 230) to an RF source or a reader. In the example of FIG. 2, the network entity 105-a may configure (e.g., dynamically, statically, semi-statically) the UE 115-a and the UE 115-b with the TTI structure 235. That is, the network entity 105-a may configure the TTI structure 235 and may transmit the TTI structure indication 230 via L1, L2, or L3 signaling to the UE 115-a and the UE 115-b. For instance, the network entity 105-a may include the TTI structure indication 230 as part of a control message (e.g., RRC signaling, a MAC control element (MAC-CE), downlink control information (DCI)). Each UE 115 may forward (e.g., relay) the TTI structure indication 230 to the ambient device(s) 205 with which the UE 115 communicates.

In some cases, whether the UE 115-a or the network entity 105-a configures the TTI structure 235 may be based on which device acts as an RF source for an ambient device 205. Put another way, the TTI structure 235 may be configured by an RF source that provides a continuous waveform 220 to an ambient device 205, regardless of a type of device of the RF source (e.g., regardless of whether the RF source is a network entity 105 or a UE 115). Alternatively, when the RF source is a UE 115 (e.g., the UE 115-a, the UE 115-b), the network entity 105-a may configure the TTI structure 235 and may transmit the TTI structure indication 230 to the UE 115.

In some examples, an ambient device 205 may indicate a preferred TTI structure 235 to a reader based on data of the ambient device 205, an energy status of the ambient device 205, or the like, among other examples. In the example of FIG. 2, prior to receiving FL data from or sending BL data to the UE 115-a, the ambient device 205-a may send (e.g., to the UE 115-a) an indication of a TTI structure 235 that the ambient device 205-a prefers for subsequent communications. If the ambient device 205-a has relatively low energy levels in an energy storage, the ambient device 205-a may prefer a TTI structure 235 that includes an increased quantity of FL data TTIs 240. Additionally, or alternatively, the ambient device 205-a may indicate a preferred TTI structure 235 based on an amount of data of the ambient device 205-a. For example, if the ambient device 205-a has a relatively large amount of data to send, the ambient device 205-a may prefer a TTI structure 235 with an increased quantity of BL data TTIs 240. Conversely, if the ambient device 205-a has a relatively small amount of data to send, the ambient device 205-a may prefer a TTI structure 235 with fewer BL data TTIs 240.

While a TTI structure 235 may improve efficiency and reliability of ambient device communications, some interference may still occur in scenarios with multiple ambient devices 205, readers, and RF sources. As a specific example, interference may be introduced when two modulated signals (e.g., FL data, BL data) are communicated in a same communication direction and within a same TTI 440. For example, the UE 115-a and the UE 115-b may each communicate with one or more ambient devices 205 according to a same TTI structure 235. When the UE 115-a and the UE 115-b are relatively geographically close to one another, they may experience interference in TTIs 240 that are associated with a same communication direction (e.g., BL data, FL data). Thus, network devices that are within a threshold relative distance of one another may implement different TTI structures 235, such that respective TTIs 240 of each TTI structure 235 are associated with different communication directions. That is, network devices communicating with ambient devices 205 may configure respective TTI structures 235 to achieve interference cancellation.

To this end, the UE 115-a and the UE 115-b may exchange a message 245 that indicates their respective TTI structures 235. If the respective TTI structures 235 are the same or have one or more overlapping TTIs 240, or if the UEs 115 are within a threshold relative distance of one another, one or both of the UE 115-a and the UE 115-b may use a different TTI structure 235. For example, the UE 115-a may switch to a different preconfigured TTI structure 235, or may modify one or more TTIs 240 of the TTI structure 235 (e.g., may allocate one or more TTIs 240 to be associated with a different communication direction). Additionally, or alternatively, the UE 115-a may convert one or more TTIs 240 to an empty symbol (e.g., a mute symbol or a gap symbol), such that no transmissions occur in the one or more TTIs 240.

The threshold relative distance may be determined by one or more characteristics of the message 245, such as a reference signal received power (RSRP), a reference signal received quality (RSRQ), a received signal strength indicator (RSSI), or the like, among other examples. A UE 115 receiving the message 245, such as the UE 115-a, may measure the one or more characteristics to obtain a measurement value to compare to the threshold relative value. Additionally, or alternatively, each UE 115 may include, in the message 245, information that indicates a geographic location of the UE 115, such as a zone identifier (ID), and the UE receiving the message 245 (e.g., the UE 115-a) may determine a measurement value indicative of a geographic distance between the UEs 115. If the measurement value satisfies the threshold relative value (e.g., if the UEs 115 are relatively far apart), the UE 115-a may refrain from modifying the TTI structure 235. If the measurement value fails to satisfy the threshold relative value, the UE 115-a may modify or change the TTI structure 235 (e.g., may modify one or more TTIs 240 of the TTI structure 235 or may use a different TTI structure 235).

In some examples of bistatic communications, the TTI structure 235 may include one or more TTIs 240 allocated for communications between network devices, such as an RF source and a reader, a reader and a network entity 105, or an RF source and a network entity 105. As discussed with reference to FIGS. 3-5, for example, a reader may forward a received BL signal 225 to an RF source in such a TTI 240. Additionally, or alternatively, the reader may use the TTI 240 to transmit feedback information (e.g., a negative acknowledgement (NACK), a positive acknowledgement (ACK)) to the RF source. In another example, the reader and the RF source may communicate a synchronization signal (e.g., a synchronization signal block (SSB)) for performing synchronization between the reader and the RF source. The reader, the RF source, or both, may use the synchronization signal for frequency tracking loops (FTL), time tracking loops (TTL), or automatic gain control (AGC), or as part of discontinuous reception procedures, among other examples.

FIG. 3 shows an example of a frame structure 300 that supports a TTI structure for ambient wireless device communications in accordance with one or more aspects of the present disclosure. In some examples, aspects of the frame structure 300 may implement, or be implemented by, aspects of the wireless communications system 100, the wireless communications system 200, or both. In particular, the frame structure 300 illustrates an example configuration of resources allocated for communications between one or more ambient devices and one or more network devices (e.g., one or more RF sources, one or more readers, or a combination thereof). The one or more ambient devices may be examples of corresponding ambient wireless devices described herein. The one or more network devices may be examples of UEs 115, network entities 105, or a combination thereof, as described herein.

For example, a network device (e.g., an RF source, a reader) may configure the frame structure 300 and may transmit an indication (e.g., a bitmap 325, a set of control bits) of the frame structure 300 to the one or more ambient devices or to another network device (e.g., a UE) in communication with the one or more ambient devices. The frame structure 300 may be for a frame 305 that includes a set of slots, where each slot is associated with a respective communication direction (e.g., uplink, downlink, FL, BL), and where a subset of slots of the set of slots is allocated for ambient device communications (e.g., FL and BL communications). The frame structure 300 may be repeated, for example, every 10 slots.

In some examples, the frame 305 may be an example of an NR frame that includes a set of NR subframes and a set of NR slots, where each NR subframe includes two NR slots. The set of NR slots may include a quantity (e.g., nine) of downlink slots and a quantity (e.g., one) of uplink slots, and configuring the frame structure 300 may include the network device selecting one or more of the downlink slots and, in some cases, the uplink slot, to be used for the ambient device communications (e.g., to be used as ambient device slots 310). In some cases, the network device may select slots to be used as ambient device slots 310 based on a device type of an RF source communicating with the ambient device. For example, if the RF source is a network entity (e.g., a network entity 105), the network device may select only downlink slots, while if the RF source is a UE (e.g., a UE 115), the network device may select only uplink slots. In another example, the network device may select from among both uplink and downlink slots to be used as ambient device slots 310, e.g., to achieve improved communications efficiency with the ambient device or to provide continuous power to the ambient device (e.g., via a continuous waveform).

In the example of FIG. 3, the frame structure 300 includes four ambient device slots 310 (e.g., allocated for signals sent to or from an ambient device), five downlink slots 315, and one uplink slot 320. Thus, in configuring the frame structure 300, the network device may select four downlink slots to be used as ambient device slots 310. Additionally, in some cases, the network device may configure (e.g., select) one or more frequency domain resources (e.g., one or more subchannels) to be allocated for the ambient device communications.

Additionally, or alternatively, the frame 305 may be understood as an ambient device frame, and the frame structure 300 may be understood or referred to as an ambient device frame structure. An ambient device frame may be defined as a set of TTIs that includes at least one TTI for ambient device communications, and an ambient device frame structure may be defined as a format (e.g., a TTI format) for an ambient device frame. Here, the ambient device frame may include a set of ambient device TTIs, such as ambient device slots (e.g., ambient device slots 310) or ambient device symbols, and the ambient device frame structure may indicate a resource allocation for the ambient device TTIs.

In some cases, an ambient device frame may have a duration in a time domain that is equal to that of an NR frame, while in other cases, the ambient device frame may have a duration that is less than or greater than that of an NR frame. For instance, an ambient device frame may have a duration (e.g., length) equal to a set of NR slots or a set of NR symbols. Likewise, an ambient device TTI may have a duration equal to, less than, or greater than that of an NR slot. As an example, an ambient device TTI (e.g., an ambient device slot 310) may have a time duration equivalent to a set of multiple NR slots. Alternatively, an ambient device TTI (e.g., an ambient device slot 310) may have a time duration equivalent to a set of multiple NR symbols. In some examples, each ambient device TTI of an ambient device frame may have a respective time duration, which may vary between TTIs or over time. For example, in a first ambient device frame structure, a first ambient device slot 310 (e.g., an ambient device slot 310-a) may have a first time duration that is different from a second time duration of a second ambient device slot 310 (e.g., an ambient device slot 310-b). In a second ambient device frame structure, the first ambient device slot 310 may have a third time duration that is different from the first time duration. In some cases, a time duration of an ambient device TTI may be based on communications for which the ambient device TTI is allocated.

An ambient device slot 310 may be a TTI (e.g., an NR slot, an ambient device TTI) in which a network device may transmit FL data (e.g., commands, queries, continuous waves, or the like) to an ambient device, and in which the ambient device may send a response (e.g., BL data, such as a backscattered signal) to the network device. In some examples, ambient device slots 310 of a frame structure 300 may be contiguous in a logical domain, but may be discrete in a physical domain. For instance, in the logical domain, an ambient device slot 310-a and an ambient device slot 310-b may be contiguous (e.g., the ambient device slot 310-b may be subsequent to the ambient device slot 310-a), but in the physical domain, the ambient device slot 310-a and the ambient device slot 310-b may be separated by downlink slots 315-a, 315-b, and 315-c.

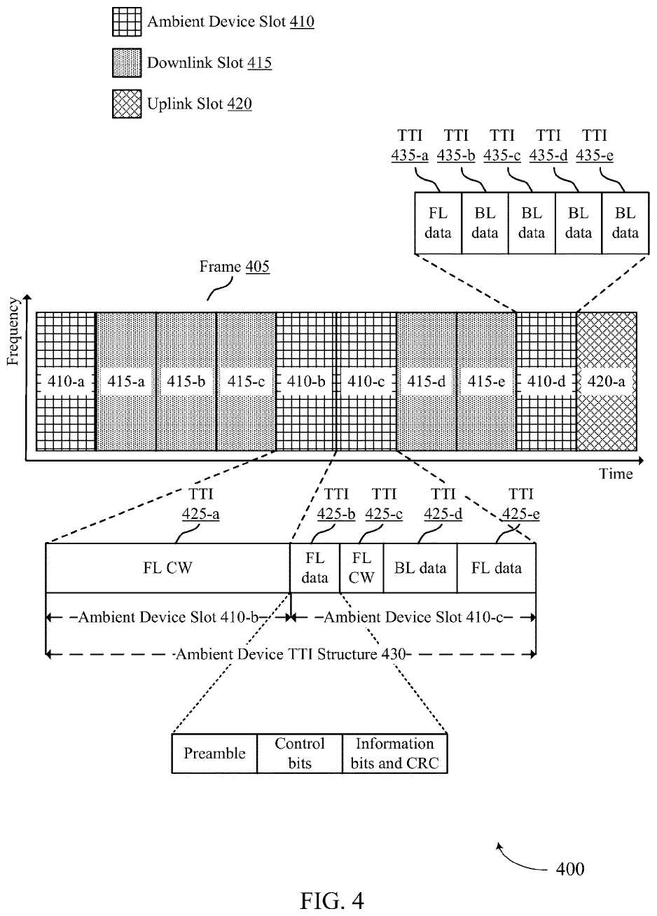

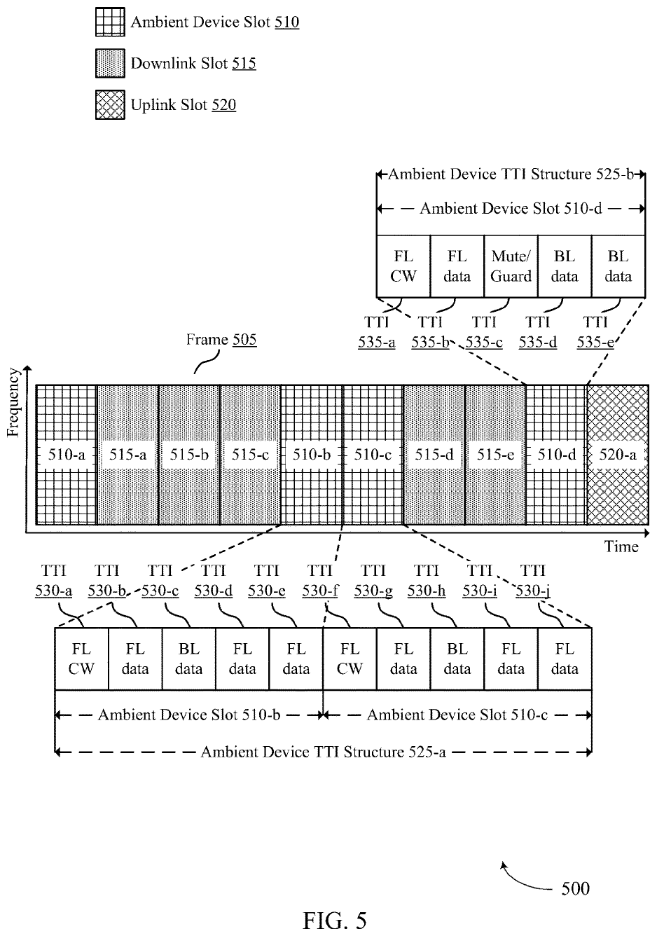

As discussed with reference to FIGS. 4-5, an ambient device slot 310 may include a set of symbols. In some cases, the network device may configure the set of symbols of the ambient device 310. For instance, a first subset of symbols of the set of symbols may be allocated for FL data, a second subset of symbols of the set of symbols may be allocated for a continuous wave, and a third subset of symbols of the set of symbols may be allocated for BL data. Additionally, or alternatively, an ambient device slot 310, or one or more symbols of the ambient device slot 310, may be allocated for ambient device communications between network devices, e.g., between a reader and an RF source, a reader and a network entity, an RF source and a network entity, or some combination thereof.

The network device may configure the frame structure 300, the ambient device slots 310, or both, for a group of ambient devices or per ambient device. For example, the network device may allocate a respective ambient device slot 310 and, in some cases, a respective subchannel, to each ambient device of a group of ambient devices. Thus, each ambient device may be assigned a set of resources in which to communicate with the network device, which may reduce interference and improve reliability. Additionally, or alternatively, the network device may allocate a same ambient device slot 310 for multiple ambient devices, such that the network device may simultaneously communicate with the multiple ambient devices, which may reduce latency and improve resource utilization efficiency. In this example, the network device may further reduce interference among ambient devices by assigning each ambient device a respective (e.g., different) subchannel.

In some examples, the network device may transmit the indication of the frame structure 300 within a set of control bits of an FL data packet (e.g., transmitted within an ambient device slot 410). Here, the set of control bits may indicate a respective duration of each TTI (e.g., each ambient device slot 310), a total duration for the frame structure 300 (e.g., a quantity of NR slots included in the frame structure 400), a frequency domain bandwidth allocated for the ambient device communications, or the like, among other examples. In some cases, the set of control bits may indicate a pattern of time-frequency resources from a set of time-frequency resources for the frame structure 300. The pattern of time-frequency resources may correspond to time resources (e.g., TTIs) and frequency resources (e.g., subchannels) of the frame structure 300 in which the ambient device may communicate. That is, a pattern of time-frequency resources may indicate a resource format for the frame structure 300.

Additionally, or alternatively, the indication of the frame structure 300 may include or be an example of a bitmap 325 indicating which slots of a frame 305 are selected for ambient device communications. Each bit of the bitmap 325 may correspond to a respective slot of the frame structure 300 (e.g., of the frame 305), where a value of a bit indicates whether the corresponding slot is an ambient device slot 310. In some cases, the bitmap 325 may include a set of bits based on whether the frame structure 300 is configured to utilize, as ambient device slots 310, only downlink slots, only uplink slots, or both uplink and downlink slots. For example, when the network device selects both uplink and downlink slots, the bitmap 325 may include a quantity of bits equal to a quantity of slots in the frame structure 300. This example is illustrated in bitmap 325-a, where a bit value of 1 may indicate that the corresponding slot is to be used for ambient device communications, while a bit value of 0 may indicate that the corresponding slot is not an ambient device slot 310 and is to be used as its original slot type (e.g., a downlink slot 315 or an uplink slot 320 in accordance with an NR frame).

Alternatively, bitmap 325-b may be utilized when uplink slots are not used as ambient device slots 310. Here, the bitmap 325-b may include a quantity of bits equal to a quantity of available slots, where a slot is “available” to be selected as an ambient device slot 310 based on the communication direction associated with the slot. Thus, the bitmap 325-b includes 9 bits (e.g., one bit per downlink slot of the frame 305), and each bit of the bitmap 325-b corresponds to a downlink slot. A value of a bit may indicate whether the corresponding slot is an ambient device slot 310. For instance, a bit value of 1 may indicate that the corresponding slot is to be used for ambient device communications, while a bit value of 0 may indicate that the corresponding slot is a downlink slot 315. An uplink slot, such as an uplink slot 320, may not have a corresponding bit.

FIG. 4 shows an example of a frame structure 400 that supports a TTI structure for ambient wireless device communications in accordance with one or more aspects of the present disclosure. In some examples, aspects of the frame structure 400 may implement, or be implemented by, aspects of the wireless communications system 100, the wireless communications system 200, or both. In particular, the frame structure 400 illustrates an example configuration of resources allocated for communications between one or more ambient devices and one or more network devices (e.g., one or more RF sources, one or more readers, or a combination thereof). The one or more ambient devices may be examples of corresponding ambient wireless devices described herein. The one or more network devices may be examples of UEs 115, network entities 105, or a combination thereof, as described herein.

For example, a network device (e.g., an RF source, a reader) may configure the frame structure 400 and may transmit an indication (e.g., a bitmap, a set of bits) of the frame structure 400 to the one or more ambient devices or to another network device (e.g., a UE) in communication with the one or more ambient devices. In some examples, the frame structure 400 may be for a frame 405 (e.g., an NR frame) that includes a set of slots (e.g., 10 slots), where each slot is associated with a respective communication direction (e.g., uplink, downlink, FL, BL), and where a subset of slots of the set of slots is allocated for ambient device communications (e.g., FL and BL communications). That is, the frame structure 400 may have a time duration equivalent to that of an NR frame. In such examples, the frame structure 400 may be defined as a pattern (e.g., format) of slots for ambient device communications, and may indicate a set of ambient device slots 410, a set of downlink slots 415, and a set of uplink slots 420. An ambient device receiving the indication of the frame structure 400 may monitor for FL data and may send BL data in corresponding ambient device slots 410, e.g., in accordance with the frame structure 400.

Additionally, or alternatively, the frame structure 400 may be for or otherwise include any quantity or type of TTIs (e.g., ambient device slots, ambient device symbols, NR slots, NR symbols). For instance, the frame structure 400 may include or be an example of a TTI structure for one or more slots (e.g., NR slots, ambient device slots) within a frame 405, where the one or more slots are allocated for ambient device communications. Here, the frame structure 400 may indicate a pattern of TTIs (e.g., NR symbols, ambient device symbols) in the one or more slots. For example, the frame structure 400 may indicate a pattern of ambient device TTIs (e.g., TTIs allocated for ambient device communications) within an ambient device slot, a pattern of ambient device TTIs within an NR slot, a pattern of ambient device slots within an NR slot, or some combination thereof. In the example of FIG. 4, the frame structure 400 may indicate a pattern of TTIs 425 in an ambient device slot 410-c, a pattern of TTIs 435 in an ambient device slot 410-d, or a combination thereof. The techniques described herein support any combination of TTIs, types of TTIs (e.g., NR or ambient device), time durations, or the like, and the examples discussed herein should not be construed as limiting.

Each slot in the frame structure 400 may have a respective time duration (e.g., length). An ambient device slot may have a time duration equal to one or more NR slots or one or more NR symbols, and the time duration may vary between ambient device slots (e.g., a first ambient device slot may have a time duration different from that of a second ambient device slot). In the example of FIG. 4, the ambient device slots 410, the downlink slots 415, and the uplink slot 420 may each have a time duration equivalent to an NR slot. Each TTI (e.g., each TTI 425, each TTI 435) may have a respective time duration, which may differ between TTIs. In some cases, a TTI, or a group of TTIs, may have a time duration equivalent to an NR slot. For example, as illustrated, the ambient slot 410-b includes a TTI 425-a allocated for an FL continuous wave, where the TTI 425-a occupies the entirety of the ambient slot 410-b (e.g., the TTI 425-a has a time duration equal to the time duration of the ambient slot 410-b, which, in turn, is equal to a time duration of an NR slot). Alternatively, the ambient slot 410-c includes multiple TTIs 425 that each have a respective time duration that is less than that of an NR slot, where the TTIs 425 have a total time duration equal to an NR slot. Further, each TTI 425 within the ambient device slot 410-c may have a different respective time duration. As yet another example, an ambient slot 410-d includes multiple TTIs 435, where each TTI 435 has a same time duration.

A pattern of ambient device TTIs may divide an ambient slot 410 into a quantity of TTIs allocated for FL data and a quantity of TTIs allocated for BL data. The frame structure 400 may allocate TTIs within each ambient device slot 410, for example, based on whether a TTI is to be used for FL signals (e.g., FL data, a continuous wave), BL signals, or some other signals. Thus, the frame structure 400 may indicate a pattern of TTIs (e.g., symbols) within each ambient device slot 410, where each TTI is associated with a respective communication direction between the network device and the ambient device. For example, within each ambient device slot 410, the frame structure 400 may indicate a first quantity of TTIs allocated for a continuous wave, a second quantity of TTIs allocated for FL data, a third quantity of TTIs allocated for BL data, or some combination thereof. In some cases, the network device may configure a time duration for a TTI based on a communication direction associated with the TTI. For instance, a TTI allocated for a continuous wave may have a relatively long time duration to enable the ambient device to power up one or more components using the continuous wave.

In some examples, a pattern of ambient device TTIs may be referred to as an ambient device TTI structure. An ambient device TTI structure, such as an ambient device TTI structure 430, may include one or more ambient device slots 410, where each ambient device slot 410 includes one or more ambient device TTIs. In some cases, an ambient device TTI structure may include one ambient device slot 410, while in other cases, an ambient device TTI structure may include multiple ambient device slots 410. In the example of FIG. 4, the TTIs 425 may collectively be referred to as an ambient device TTI structure 430 that spans (e.g., includes) two slots (e.g., the ambient device slot 410-b and the ambient device slot 410-c). This ambient device TTI structure may have a time duration equivalent to two NR slots. As another example, the TTIs 435 may be collectively referred to as an ambient device TTI structure that occupies one slot (e.g., the ambient device slot 410-d) and has a time duration equivalent to one NR slot.

The network device may transmit the indication of the frame structure 400 to the ambient device and, in some cases, one or more other network devices. The indication of the frame structure 400 may include or be an example of a bitmap, a set of bits indicating a pattern of time-frequency resources (e.g., TTIs and frequency resources) for the frame structure 400, a set of control bits, or the like, among other examples. For example, the network device may select a pattern of ambient device TTIs and frequency resources (e.g., subchannels) from a set of patterns associated with ambient device communications (e.g., associated with frame structures such as the frame structure 400), and may indicate the selected pattern to the ambient device. In some cases, the network device may configure (e.g., via RRC signaling) the ambient device with the set of patterns of time-frequency resources and may dynamically indicate (e.g., via DCI or MAC-CE) a pattern to the ambient device for subsequent communications.

In another example, the network device may transmit a bitmap that indicates the frame structure 400 (e.g., the pattern of TTIs of the ambient device slot 410). A value of each bit of the bitmap may indicate a whether a corresponding TTI is to be used for ambient device communications. Additionally, or alternatively, a value of each bit of the bitmap may indicate a communication direction for the TTI, such as whether the TTI is to be used for FL data, BL data, or the like. The ambient device receiving the indication may monitor for FL data and send BL data in the corresponding TTIs. In some cases, the frame structure 400 may be repeated, e.g., per frame 405, per ambient device slot 410, or both.

In some examples, an ambient device TTI structure may be aligned in a time domain with an NR slot. For instance, in the ambient device TTI structure 430, the TTIs 425 may be aligned with the ambient device slot 410-c in the time domain. Additionally, an ambient device frame may be aligned with an NR frame in the time domain. Alternatively, an ambient device frame may not be aligned with an NR frame in the time domain.

Additionally, or alternatively, an ambient device slot 410, or one or more symbols of an ambient device slot 410, may be allocated for ambient device communications between network devices, e.g., between a reader and an RF source, a reader and a network entity, an RF source and a network entity, or some combination thereof.

An ambient device slot 410 may be a TTI in which a network device may transmit FL data (e.g., commands, queries, continuous waves, or the like) to an ambient device, and in which the ambient device may send a response (e.g., BL data, such as a backscattered signal) to the network device. In some examples, an ambient device slot 410 may be equivalent to an NR slot. In other examples, however, an ambient device slot 410 may be equivalent to a portion of an NR slot, or may be equivalent to multiple NR slots. For example, an ambient device slot 410 may be equivalent to an NR mini-slot, e.g., may include fewer symbols than a downlink slot 415. Moreover, one or more ambient device slots 410 of a frame structure 400 may be contiguous in a logical domain, but may be discrete in a physical domain. For instance, an ambient device slot 410-a and an ambient device slot 410-b may be defined as a single ambient device slot and may be contiguous in the logical domain, but in the physical domain, the ambient device slot 410-a and the ambient device slot 410-b may be separated by downlink slots 415-a, 415-b, and 415-c.

In the example of FIG. 4, the frame structure 400 includes four ambient device slots 410 (e.g., allocated for signals sent to or from an ambient device), five downlink slots 415, and one uplink slot 420. Each ambient device slot 410 may be further divided into a set of TTIs (e.g., symbols), where each TTI of the set of TTIs is allocated for FL communications or BL communications. For example, the ambient device slots 410-b and 410-c includes a TTI 425-a and a TTI 425-c allocated for a continuous wave; a TTI 425-b and a TTI 425-e allocated for FL data; and a TTI 425-d allocated for BL data. The ambient device slot 410-d includes a TTI 435-a allocated for FL data and TTIs 435-b through 435-e allocated for BL data. In some examples, each ambient device slot 410 may be configured with a same pattern of TTIs. For example, although not shown, the ambient device slot 410-a may also include TTIs 435.

An unmodulated signal, such as a continuous wave, or an empty (e.g., carrying no information) modulated signal, may be received by the ambient device within an allocated TTI (e.g., the TTI 425-a) for activation of the ambient device. For example, the ambient device may be a passive device and may utilize energy from the continuous wave to activate or otherwise power up one or more components of the ambient device. In such examples, the allocated TTI may have a time duration based on the activation. That is, TTIs allocated for a signal to be used for activation of the ambient device may have a time duration equivalent to one or more NR slots. Alternatively, if the ambient device is an active device or a semi-passive device and does not rely on a received signal for power, the network device may refrain from allocating any TTIs for a continuous wave (or other activation signal).

FL data may be transmitted by the network device to the ambient device. In some cases, FL data may also refer to communications between an RF source and a reader, e.g., in bistatic communications. Examples of FL data may include, but are not limited to, a continuous wave for activation of or supplying power to the ambient device, feedback information (e.g., ACK/NACK), one or more commands from an RF source, or information for a writing operation at the ambient device (e.g., information to be written to the ambient device), or the like. For instance, an FL data packet communicated in an FL data TTI, such as the TTI 425-b, may include a preamble, a set of control bits, a set of information bits, and one or more cyclic redundancy check (CRC) bits.

Additionally, FL data may include an indication of cast type (e.g., broadcast, groupcast, unicast) for the ambient device communications, a TDD pattern, a time domain resource allocation, a frequency domain resource allocation, or a repetition factor. A respective repetition factor may be indicated for each of a continuous wave, FL data, and BL data. The repetition factor for an ambient device communication may be based on a class of the ambient device, associated latency requirements, associated quality of service (QoS) requirements, or an associated priority, among other examples. In some cases, the repetition factor may be explicitly indicated for a respective TTI, while in other cases, a receiving device (e.g., an ambient device, an RF source, a reader) may determine the repetition factor based on the associated latency requirements, QoS, or priority.

A TTI allocated for FL communications (e.g., FL data, a continuous wave) may be referred to as a FL data occasion and a TTI allocated for BL communications may be referred to as a BL data occasion. One FL data occasion may be associated with multiple BL data occasions, particularly in groupcast communications. For instance, the network device may communicate with the group of ambient devices by broadcasting or groupcasting a query in the TTI 425-b. Each ambient device may respond to the query in a respective BL data occasion, such as a respective TTI 435.

In some cases, the network device may utilize an FL signal (e.g., FL data) to allocate resources to the ambient device or to a group of ambient devices. For example, the network device may indicate the frame structure 400 to the ambient device within a set of control bits of an FL data packet transmitted within a TTI 425, such as the TTI 425-b, or an ambient device slot 410. Here, the set of control bits may indicate a pattern of time-frequency resources (e.g., from a set of patterns of time-frequency resources) for the frame structure 400, a respective duration of each TTI (e.g., each ambient device slot 410, each TTI 425, each TTI 435), a total duration for the frame structure 400 (e.g., a quantity of NR slots included in the frame structure 400), a frequency domain bandwidth allocated for the ambient device communications, or the like, among other examples. In some examples, the network device may indicate the frame structure 400 to the ambient device to allocate time domain resources, and may indicate, within a TTI (e.g., a TTI 425, an ambient device slot 410) of the frame structure 400, a frequency domain allocation for the ambient device or the group of ambient devices. The frequency domain allocation may include an indication of the one or more subchannels, a subchannel size (e.g., bandwidth), a quantity of subchannels, a subchannel index, a subchannel index range, or the like. As another example, a FL data occasion associated with one or more BL data occasions may indicate a resource allocation for the one or more BL data occasions. The FL data occasion may indicate a time domain resource duration, a time domain offset, a frequency domain bandwidth, one or more frequency domain resource blocks, or the like, for the one or more BL data occasions.

In some cases, FL data may include a dynamic or a semi-static configuration of the frame structure 400. The network device may dynamically or semi-statically configure an ambient device slot 410, a set of TTIs, or both. In the example of FIG. 4, the network device may configure the ambient device slots 410-a, 410-b, and 410-c with TTIs 425 that include one TTI 425-d for BL data. The network device may transmit, to the group of ambient devices, a query in the TTI 425-e of the ambient device slot 410-c. Based on a quantity of ambient devices in the group of ambient devices, the network device may determine that one TTI (e.g., a TTI 425-d) is not sufficient to receive BL data responses to the query from the ambient devices. Thus, the network device may dynamically modify the frame structure 400 such that a subsequent ambient device slot 410 (e.g., the ambient device slot 410-d) includes an increased quantity of TTIs 435 allocated for BL data from the ambient devices.

The network device may, for example, modify respective communication directions for which each TTI 435 is allocated. The network device may transmit an indication of the modified TTI structure to the ambient devices in a TTI 435-a, such that the ambient devices use the modified TTI structure in subsequent communications (e.g., in subsequent TTIs 435). Alternatively, the network device may transmit, in the TTI 435-a, an explicit resource allocation indication for each of the TTIs 435-b, 435-c, 435-d, and 435-e. That is, the network device may indicate, in the TTI 435-a, a resource allocation (e.g., a time domain resource allocation, a frequency domain resource allocation) for one or more BL data occasions associated with the TTI 435-a.

The network device may configure the frame structure 400, the ambient device slots 410, or both, for a group of ambient devices or per ambient device. For example, the network device may allocate a respective ambient device slot 410, and, in some cases, a respective subchannel, to each ambient device of a group of ambient devices. Alternatively, the network device may allocate a respective TTI 425 of an ambient slot 410 to each ambient device. In either case, each ambient device may be assigned a set of resources in which to communicate with the network device, which may reduce interference and improve reliability. Additionally, or alternatively, the network device may allocate a same ambient device slot 410 for multiple ambient devices, such that the network device may simultaneously communicate with the multiple ambient devices, which may reduce latency and improve resource utilization efficiency. In this example, the network device may further reduce interference among ambient devices by assigning each ambient device a respective (e.g., different) subchannel.

In some cases, the network device may configure a frame structure and one or more TTI structures for the frame 405. For example, the network device may be an example of a network entity configuring a UE with ambient device TTIs for the UE to communicate with the ambient device. The network device may transmit, to the UE, an initial configuration of a frame structure for the frame 405, where the frame structure indicates a pattern of slots (e.g., a pattern of respective communication directions associated with each slot) for the frame 405. That is, the frame structure may indicate the ambient device slots 410, the downlink slots 415, and the uplink slot 420. The network device may subsequently transmit an indication of a TTI structure, where the TTI structure indicates a pattern of TTIs within one or more ambient device slots 410. For example, the TTI structure may indicate a first subset of symbols allocated for FL data and a second subset of symbols allocated for BL data. In some cases, the TTI structure may further indicate a third subset of symbols allocated for a continuous wave.

FIG. 5 shows an example of a frame structure 500 that supports a TTI structure for ambient wireless device communications in accordance with one or more aspects of the present disclosure. In some examples, aspects of the frame structure 500 may implement, or be implemented by, aspects of the wireless communications system 100, the wireless communications system 200, or both. In particular, the frame structure 500 illustrates an example configuration of resources allocated for communications between one or more ambient devices and one or more network devices (e.g., one or more RF sources, one or more readers, or a combination thereof). The one or more ambient devices may be examples of corresponding ambient wireless devices described herein. The one or more network devices may be examples of UEs 115, network entities 105, or a combination thereof, as described herein.

For example, a network device (e.g., an RF source, a reader) may configure the frame structure 500 and may transmit an indication (e.g., a bitmap, a set of control bits) of the frame structure 500 to the one or more ambient devices or to another network device (e.g., a UE) in communication with the one or more ambient devices. In the example of FIG. 5, the frame structure 500 may be for a frame 505 (e.g., an NR frame) that includes a set of slots (e.g., 10 slots). The set of 10 slots includes four ambient device slots 510 associated with ambient device communications, five downlink slots 515 allocated for downlink communications, and one uplink slot 520 allocated for uplink communications. Each ambient device slot 510 may be further divided into a set of TTIs, where each TTI of the set of TTIs is allocated for FL/BL communications. The frame structure 500 may therefore indicate a pattern (e.g., format) of slots and one or more patterns of TTIs within each slot. In some examples, a set of TTIs may be referred to or understood as an ambient device TTI structure 525, which may be defined as a pattern of ambient device TTIs that spans one or more slots (e.g., one or more ambient device slots 510).

For example, an ambient device TTI structure 525-a may include two ambient device slots 510, where each ambient device slot 510 has a time duration equal to a time duration of an NR slot, and the ambient device TTI structure 525-a has a time duration equal to that of two NR slots. An ambient device slot 510-b may include a TTI 530-a allocated for a continuous wave; a TTI 530-b, a TTI 530-d, and a TTI 530-e allocated for FL data; and a TTI 530-c allocated for BL data. In some examples, each ambient device slot 510 of the ambient device TTI structure 525-a may have a same TTI pattern (e.g., the TTI pattern may be repeated across ambient device slots 510 or within an ambient device slot 510). For example, an ambient device slot 510-c may include the same pattern of TTIs 530 (e.g., TTIs 530-f through 530-j).

In other examples, some ambient device slots 510 may be configured with different TTI patterns. As illustrated, an ambient device slot 510-d may include an ambient device TTI structure 525-b different from the ambient device TTI structure 525-a. Here, the ambient device TTI structure 525-b may have a time duration equal to that of the ambient device slot 510-d, which, in turn, may have a time duration equal to that of an NR slot. The ambient device slot 510-d (e.g., and the ambient device TTI structure 525-b) may include a TTI 535-a allocated for a continuous wave; a TTI 535-b allocated for FL data; a TTI 535-c allocated as a mute or guard symbol; and TTIs 535-d and 535-e allocated for BL data.

Additionally, one or more ambient device slots 510, or one or more symbols of an ambient device slot 510, may be allocated for ambient device communications between network devices, e.g., between a reader and an RF source, a reader and a network entity, an RF source and a network entity, or some combination thereof. For example, the frame structure 500 may be implemented in bistatic communications between an RF source, a reader, and an ambient device. The RF source may transmit a continuous wave to the ambient device in the TTI 530-a, followed by one or more commands as FL data in the TTI 530-b. The ambient device may respond to the one or more commands by sending BL data to the reader in the TTI 530-c. A TTI allocated for FL data, such as the TTI 530-d, may be utilized as a feedback TTI in which the reader transmits feedback information associated with the BL data, e.g., to the RF source or to a network entity associated with the ambient device communications. The feedback information may include an ACK or a NACK. Additionally, in some examples, a TTI allocated for FL data, such as the TTI 530-e, may be utilized for relaying the BL data to the RF source. For instance, if the reader successfully receives the BL data in the TTI 530-c, the reader may transmit an ACK to the RF source in the TTI 530-d and may forward the BL data to the RF source in the TTI 530-e.

In another example, one or more ambient device slots 510, or one or more symbols of an ambient device slot 510, may be allocated as guard intervals. A guard interval may include or be an example of a continuous wave (e.g., an unmodulated signal), a mute symbol (e.g., a symbol in which no signals are transmitted), or a modulated signal that does not include useful information. In some cases, one or more guard symbols may be inserted between TTIs allocated for FL data and TTIs allocated for BL data. For example, the frame structure 500 may be configured to include a guard interval between the TTI 535-b allocated for FL data and the TTI 535-d allocated for BL data. In monostatic communications, for example, the network device acting as both RF source and reader may transmit FL data in a TTI 535-b. The network device may utilize a mute or guard symbol, such as the TTI 535-c, to switch from a transmission mode to a reception mode in order to receive BL data in a TTI 535-d. In some cases, a network device may transmit a continuous wave (e.g., an unmodulated signal) in a guard interval (e.g., a TTI allocated for a continuous wave may be used as a guard interval), but the network device may refrain from transmitting or receiving modulated signals. In some examples of bistatic communications, since the RF source and the reader are different devices, no mute symbol may be implemented.

Additionally, or alternatively, one or more ambient device slots 510, or one or more symbols of an ambient device slot 510, may be allocated for synchronization between the network device and the ambient device, between an RF source and a reader, or a combination thereof. FL data in the TTI 530-b, for example, may include a preamble-based, aperiodic synchronization signal. In some cases, a TTI of an ambient device slot 510, such as the TTI 530-b, may be allocated for a synchronization signal dedicated for ambient device communications, such as a low-power synchronization signal (LP-SS). An LP-SS may be periodic. In either case, the network device may transmit a synchronization signal to the ambient device in the TTI 530-b, and the ambient device may use the synchronization signal to synchronize with the network device. In another example, the RF source may transmit the synchronization signal to a reader for the reader to synchronize with the RF source. The reader, the RF source, or both, may use the synchronization signal for frequency tracking loops (FTL), time tracking loops (TTL), or automatic gain control (AGC), or as part of discontinuous reception procedures, among other examples.

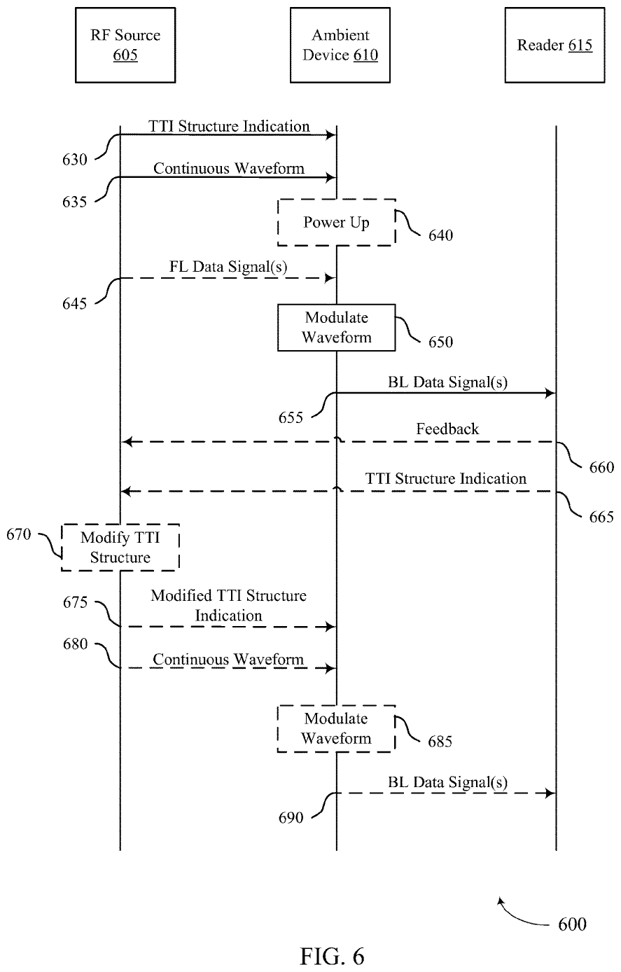

FIG. 6 shows an example of a process flow 600 that supports a TTI structure for ambient wireless device communications in accordance with one or more aspects of the present disclosure. In some examples, the process flow 600 may implement aspects of wireless communications systems 100 and 200. For example, the process flow 600 includes an RF source 605, an ambient device 610, and a reader 615, which may be examples of the corresponding devices described herein. The ambient device 610 may belong to a group of ambient devices.

In the following description of the process flow 600, the operations between the RF source 605, the ambient device 610, and the reader 615 may be transmitted in a different order than the order shown, or the operations performed by the RF source 605, the ambient device 610, and the reader 615 may be performed in different orders or at different times. Some operations may also be left out of the process flow 600, or other operations may be added to the process flow 600. It is to be understood that while the RF source 605, the ambient device 610, and the reader 615 are shown performing a number of the operations of process flow 600, any wireless device or combination of wireless devices may perform the operations shown. For example, in some cases, the RF source 605 and the reader 615 may be separate devices, while in other cases, the RF source 605 and the reader 615 may be separate components within a same device.

At 630, the RF source 605 may transmit, and the ambient device 610 may receive, an indication of a TTI structure for a slot allocated for ambient device communications. The indication of the TTI structure may include or be an example of a set of control bits (e.g., of an FL data packet), a bitmap, or the like. The TTI structure may indicate a set of TTIs allocated for a group of ambient wireless devices including the ambient device 610. For example, the TTI structure may indicate at least a first TTI of the set of TTIs allocated for a continuous waveform and at least a second TTI of the set of TTIs allocated for data (e.g., a backscattered signal) from the ambient device 610. Additionally, or alternatively, the TTI structure may indicate a first quantity of TTIs of the set of TTIs that are allocated for continuous wave communications, a second quantity of TTIs of the set of TTIs that are allocated for forward link data communications, and a third quantity of TTIs of the set of TTIs that are allocated for backward link data communications.

In some cases, the first quantity of TTIs allocated for continuous wave communications may include one or more TTIs that are located prior to (e.g., in a time domain) one or more TTIs of the third quantity of TTIs allocated for backward link data communications. Additionally, or alternatively, the first quantity of TTIs may include one or more TTIs that are located subsequent to (e.g., in a time domain) the one or more TTIs of the third quantity of TTIs. In some examples, one or more TTIs of the first quantity of TTIs may be an example of a guard interval, a mute symbol, a gap symbol, or some combination thereof. Alternatively, the first quantity of TTIs may be optional (e.g., the TTI structure may only indicate the second quantity of TTIs allocated for forward link communications and the third quantity of TTIs allocated for backward link communications and may not allocate any TTIs for continuous wave communications).

In some examples, at 630, the RF source may additionally or alternatively transmit, and the ambient device 610 may receive, an indication of a frame structure for a set of slots that includes the slot. The indication of the frame structure may include or be an example of a set of control bits (e.g., of an FL data packet), a bitmap, or the like. The frame structure may indicate a respective communication direction for each slot of the set of slots. A subset of slots of the set of slots may be allocated for the ambient device communications. In some cases, the frame structure may indicate at least one slot of the set of slots that is allocated for communications between the RF source 605 and the reader 615.

In some examples, the RF source 605 may have received, from a network entity prior to 630, the indication of the TTI structure, the indication of the frame structure, or both. For instance, a network entity may configure and indicate the TTI structure to the RF source 605 and the reader 615. The RF source 605 may relay or otherwise transmit the indication of the TTI structure and the indication of the frame structure to the ambient device 610.

The indication of the TTI structure, the indication of the frame structure, or both, may include or be an example of a bitmap. For example, the indication of the TTI structure may be a bitmap indicating a pattern of symbols of the slot. The pattern of symbols may indicate a subset of symbols of the slot allocated for the ambient device communications. The indication of the frame structure may be a bitmap that indicates a subset of slots including the slot, such that each slot of the set of slots is associated with a respective uplink or downlink communication direction. In some examples, the respective communication directions of each slot of the subset of slots depend on an RF source type (e.g., a UE, a network entity) in communication with the ambient device 610, such as the RF source 605.

In some cases, the TTI structure may indicate at least one TTI of the set of TTIs that is allocated for a synchronization signal dedicated for ambient device communications. Additionally, or alternatively, the TTI structure may indicate one or more guard intervals. A guard interval may include or be an example of a continuous wave (e.g., an unmodulated signal), a mute symbol (e.g., a symbol in which no signals are transmitted), or a modulated signal that does not include useful information. For example, the TTI structure may indicate a guard interval between a TTI allocated for FL data and a TTI allocated for BL data.

In some examples, at 630, the RF source 605 may optionally transmit, and the ambient device 610 may receive, an indication of one or more subchannels allocated for the group of ambient devices. Additionally, or alternatively, the RF source 605 may transmit, and the ambient device 610 may receive, an indication of the second TTI and a subchannel allocated for the backscattered signal to be sent from the ambient device 610. Additionally, or alternatively, the RF source 605 may transmit, and the ambient device 610 may receive, an indication of a quantity of repetitions for the backscattered signal.

At 635, the RF source 605 may transmit, and the ambient device 610 may receive, in a first TTI of the set of TTIs, a continuous waveform (e.g., an unmodulated signal) for activation of the ambient device 610. The first TTI may be allocated for the continuous waveform according to the TTI structure.

At 640, the ambient device 610 may power up (e.g., activate) one or more components using energy harvested from the continuous waveform received at 635.

At 645, the RF source 605 may transmit, and the ambient device 610 may receive, one or more FL data signals. The one or more FL data signals may include feedback information, one or more commands, or the like, among other examples.

At 650, the ambient device 610 may modulate the continuous waveform with data of the ambient device 610, e.g., based on receiving the one or more FL data signals at 645.

At 655, the ambient device 610 may send, in the second TTI of the set of TTIs, a BL data signal to the reader 615 in accordance with the TTI structure indication. The BL data signal may be an example of a backscattered signal as described herein.

For example, the BL data signal may include or be an example of the continuous waveform modulated with the data of the ambient device 610, e.g., at 650.

At 660, the reader 615 may optionally transmit a message to the RF source 605. For example, if the frame structure indicates the at least one slot for communications between the RF source 605 and the reader 615, the reader 615 may utilize the at least one slot to transmit the message. In some cases, the message may include or be an example of a synchronization signal, and the reader 615 and the RF source 605 may synchronize with each other using the synchronization signal. Additionally, or alternatively, the message may indicate feedback information associated with receiving the backscattered signal (e.g., at 655). In some examples, at 660, the reader 615 may transmit (e.g., forward, relay) the backscattered signal received at 655 to the RF source 605.

At 665, the reader 615 may optionally transmit, and the RF source 605 may receive, a message indicating a second TTI structure. The second TTI structure may be for a second slot allocated for the ambient wireless device communications. In some examples, the reader 615 may modify, update, or otherwise dynamically configure the TTI structure to obtain the second TTI structure, and may indicate the second TTI structure to the RF source 605. Alternatively, the second TTI structure may be different from the TTI structure and may be associated with the reader 615 and a second group of ambient devices different from the group of ambient devices. In another example, the reader 615 may receive the second TTI structure from the network entity, e.g., for dynamic configuration of the ambient device communications.

At 670, the RF source 605 may optionally modify the TTI structure based on receiving the message indicating the second TTI structure. In some cases, the RF source 605 may modify the TTI structure based on a relative distance between the RF source 605 and the reader 615. For example, if the RF source 605 and the reader 615 are within a threshold distance, the RF source 605 may modify the TTI structure to avoid interference with the reader 615.

At 675, the RF source 605 may transmit, and the ambient device 610 may receive, an indication of the modified TTI structure. The modified TTI structure may indicate at least a third TTI allocated for data from the ambient device 610.

At 680, the RF source 605 may transmit, and the ambient device 610 may receive, a second continuous waveform, e.g., in accordance with the modified TTI structure.

At 685, the ambient device 610 may modulate the continuous waveform with data of the ambient device 610.

At 690, the ambient device 610 may send, in the third TTI, a BL data signal to the reader 615 in accordance with the modified TTI structure. The BL data signal may be an example of a backscattered signal as described herein. For example, the BL data signal may include or be an example of the continuous waveform modulated with the data of the ambient device 610, e.g., at 685.

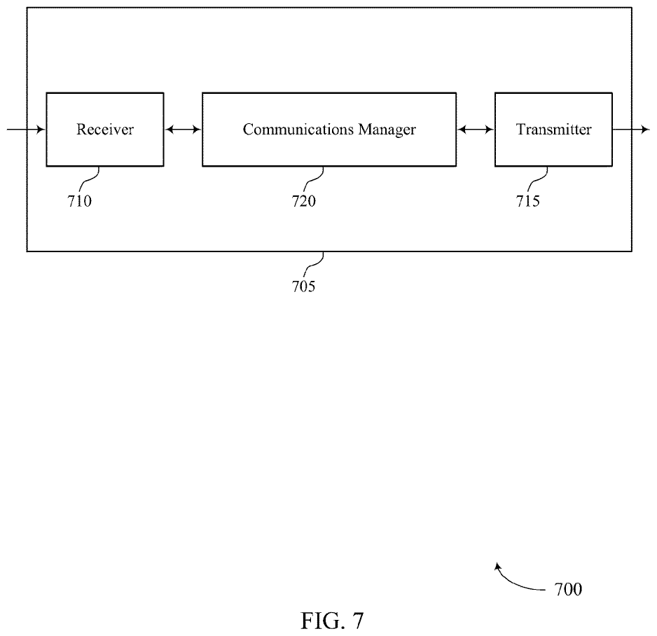

FIG. 7 shows a block diagram 700 of a device 705 that supports a TTI structure for ambient wireless device communications in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to a TTI structure for ambient wireless device communications). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to a TTI structure for ambient wireless device communications). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of a TTI structure for ambient wireless device communications as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication by an ambient wireless device in accordance with examples as disclosed herein. For example, the communications manager 720 is capable of, configured to, or operable to support a means for receiving an indication of a TTI structure for a slot allocated for ambient wireless device communications, the TTI structure indicating a set of multiple TTIs allocated for a set of multiple ambient wireless devices including the ambient wireless device. The communications manager 720 is capable of, configured to, or operable to support a means for receiving, in a first quantity of TTIs of the set of multiple TTIs, a continuous waveform for the ambient wireless device, the first quantity of TTIs allocated for continuous waveform communications according to the TTI structure. The communications manager 720 is capable of, configured to, or operable to support a means for modulating the continuous waveform with data of the ambient wireless device. The communications manager 720 is capable of, configured to, or operable to support a means for sending, in a second quantity of TTIs of the set of multiple TTIs, a backscattered signal of the continuous waveform modulated with data of the ambient wireless device, the second quantity of TTIs allocated for data from the ambient wireless device according to the TTI structure.

Additionally, or alternatively, the communications manager 720 may support wireless communication by a first wireless device in accordance with examples as disclosed herein. For example, the communications manager 720 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The communications manager 720 is capable of, configured to, or operable to support a means for transmitting, to an ambient wireless device of the set of multiple ambient wireless devices, the indication of the TTI structure. The communications manager 720 is capable of, configured to, or operable to support a means for monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

Additionally, or alternatively, the communications manager 720 may support wireless communication by a second wireless device in accordance with examples as disclosed herein. For example, the communications manager 720 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The communications manager 720 is capable of, configured to, or operable to support a means for transmitting, to an ambient wireless device of the set of multiple ambient wireless devices, the indication of the TTI structure. The communications manager 720 is capable of, configured to, or operable to support a means for transmitting, in a first quantity of TTIs of the set of multiple TTIs, a continuous waveform for the ambient wireless device, the first quantity of TTIs allocated for the continuous waveform according to the TTI structure.

By including or configuring the communications manager 720 in accordance with examples as described herein, the device 705 (e.g., at least one processor controlling or otherwise coupled with the receiver 710, the transmitter 715, the communications manager 720, or a combination thereof) may support the use of TTI structures for communications with ambient devices. As such, the techniques described herein may enable the device 705 to communicate with multiple ambient devices simultaneously, which may reduce processing and latency. Further, communicating with ambient devices according to a TTI structure may improve resource utilization efficiency.

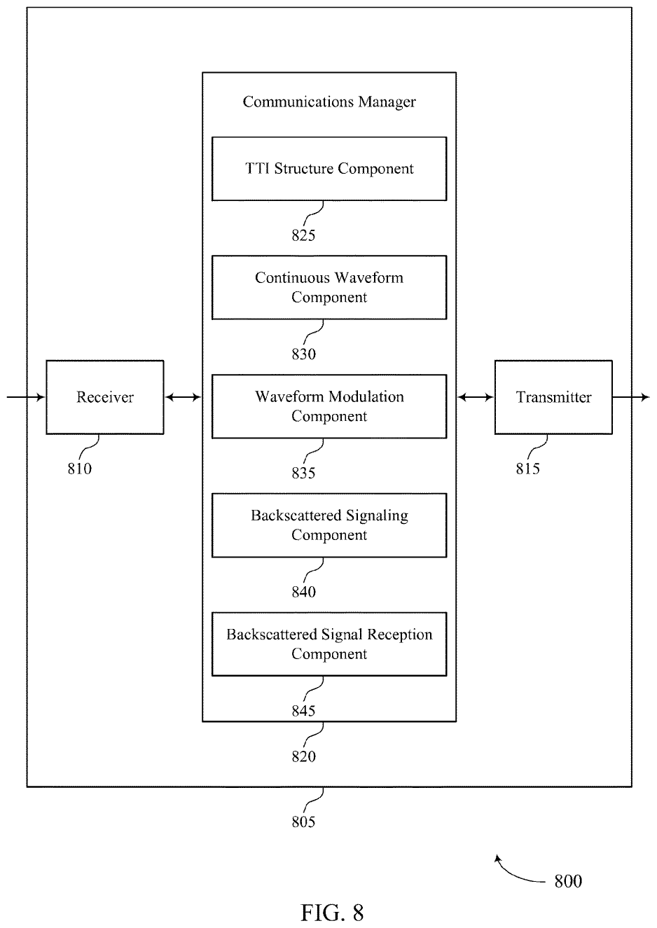

FIG. 8 shows a block diagram 800 of a device 805 that supports a TTI structure for ambient wireless device communications in accordance with one or more aspects of the present disclosure. The device 805 may be an example of aspects of a device 705 or a UE 115 as described herein. The device 805 may include a receiver 810, a transmitter 815, and a communications manager 820. The device 805, or one of more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to a TTI structure for ambient wireless device communications). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to a TTI structure for ambient wireless device communications). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of a TTI structure for ambient wireless device communications as described herein. For example, the communications manager 820 may include a TTI structure component 825, a continuous waveform component 830, a waveform modulation component 835, a backscattered signaling component 840, a backscattered signal reception component 845, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication by an ambient wireless device in accordance with examples as disclosed herein. The TTI structure component 825 is capable of, configured to, or operable to support a means for receiving an indication of a TTI structure for a slot allocated for ambient wireless device communications, the TTI structure indicating a set of multiple TTIs allocated for a set of multiple ambient wireless devices including the ambient wireless device. The continuous waveform component 830 is capable of, configured to, or operable to support a means for receiving, in a first quantity of TTIs of the set of multiple TTIs, a continuous waveform for the ambient wireless device, the first quantity of TTIs allocated for continuous waveform communications according to the TTI structure. The waveform modulation component 835 is capable of, configured to, or operable to support a means for modulating the continuous waveform with data of the ambient wireless device. The backscattered signaling component 840 is capable of, configured to, or operable to support a means for sending, in a second quantity of TTIs of the set of multiple TTIs, a backscattered signal of the continuous waveform modulated with data of the ambient wireless device, the second quantity of TTIs allocated for data from the ambient wireless device according to the TTI structure.

Additionally, or alternatively, the communications manager 820 may support wireless communication by a first wireless device in accordance with examples as disclosed herein. The TTI structure component 825 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The TTI structure component 825 is capable of, configured to, or operable to support a means for transmitting, to an ambient wireless device of the set of multiple ambient wireless devices, the indication of the TTI structure. The backscattered signal reception component 845 is capable of, configured to, or operable to support a means for monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

Additionally, or alternatively, the communications manager 820 may support wireless communication by a second wireless device in accordance with examples as disclosed herein. The TTI structure component 825 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The TTI structure component 825 is capable of, configured to, or operable to support a means for transmitting, to an ambient wireless device of the set of multiple ambient wireless devices, the indication of the TTI structure. The continuous waveform component 830 is capable of, configured to, or operable to support a means for transmitting, in a first quantity of TTIs of the set of multiple TTIs, a continuous waveform for the ambient wireless device, the first quantity of TTIs allocated for the continuous waveform according to the TTI structure.

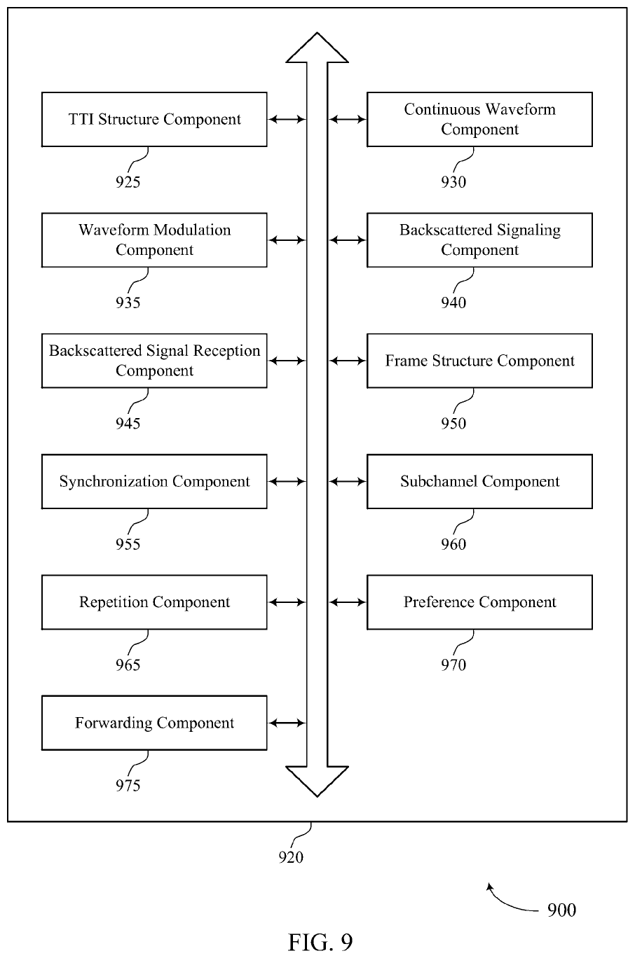

FIG. 9 shows a block diagram 900 of a communications manager 920 that supports a TTI structure for ambient wireless device communications in accordance with one or more aspects of the present disclosure. The communications manager 920 may be an example of aspects of a communications manager 720, a communications manager 820, or both, as described herein. The communications manager 920, or various components thereof, may be an example of means for performing various aspects of TTI structure for ambient wireless device communications as described herein. For example, the communications manager 920 may include a TTI structure component 925, a continuous waveform component 930, a waveform modulation component 935, a backscattered signaling component 940, a backscattered signal reception component 945, a frame structure component 950, a synchronization component 955, a subchannel component 960, a repetition component 965, a preference component 970, a forwarding component 975, or any combination thereof. Each of these components, or components or subcomponents thereof (e.g., one or more processors, one or more memories), may communicate, directly or indirectly, with one another (e.g., via one or more buses).

The communications manager 920 may support wireless communication by an ambient wireless device in accordance with examples as disclosed herein. The TTI structure component 925 is capable of, configured to, or operable to support a means for receiving an indication of a TTI structure for a slot allocated for ambient wireless device communications, the TTI structure indicating a set of multiple TTIs allocated for a set of multiple ambient wireless devices including the ambient wireless device. The continuous waveform component 930 is capable of, configured to, or operable to support a means for receiving, in a first quantity of TTIs of the set of multiple TTIs, a continuous waveform for the ambient wireless device, the first quantity of TTIs allocated for continuous waveform communications according to the TTI structure. The waveform modulation component 935 is capable of, configured to, or operable to support a means for modulating the continuous waveform with data of the ambient wireless device. The backscattered signaling component 940 is capable of, configured to, or operable to support a means for sending, in a second quantity of TTIs of the set of multiple TTIs, a backscattered signal of the continuous waveform modulated with data of the ambient wireless device, the second quantity of TTIs allocated for data from the ambient wireless device according to the TTI structure.

In some examples, the frame structure component 950 is capable of, configured to, or operable to support a means for receiving an indication of a frame structure for a set of slots including the slot, the frame structure indicating a respective communication direction for each slot of the set of slots, where a subset of slots of the set of slots is allocated for the ambient wireless device communications.

In some examples, to support receiving the indication of the frame structure, the frame structure component 950 is capable of, configured to, or operable to support a means for receiving the indication of the frame structure within a forward link data packet, the indication including a set of control bits of the forward link data packet, where the set of control bits further indicates a respective time duration of each slot of the set of slots, a total time duration of the set of slots, one or more frequency resources allocated for data from the ambient wireless device, or a combination thereof.

In some examples, the frame structure component 950 is capable of, configured to, or operable to support a means for receiving a bitmap that indicates the subset of slots, where each slot of the set of slots is associated with a respective uplink or downlink communication direction in accordance with the frame structure.

In some examples, the frame structure component 950 is capable of, configured to, or operable to support a means for receiving a set of bits that indicates a pattern of time-frequency resources for the frame structure, where the pattern of time-frequency resources is from a set of multiple patterns of time-frequency resources associated with the frame structure.

In some examples, to support receiving the indication of the TTI structure, the TTI structure component 925 is capable of, configured to, or operable to support a means for receiving the indication of the TTI structure that further indicates the first quantity of TTIs of the set of multiple TTIs that are allocated for continuous wave communications, the second quantity of TTIs of the set of multiple TTIs that are allocated for backward link data communications, and a third quantity of TTIs of the set of multiple TTIs that are allocated for forward link data communications, the first quantity of TTIs located prior to or subsequent to the second quantity of TTIs in a time domain, where at least one TTI of the first quantity of TTIs includes a guard interval between a first TTI of the third quantity of TTIs and a second TTI of the second quantity of TTIs.

In some examples, to support receiving the indication of the TTI structure, the TTI structure component 925 is capable of, configured to, or operable to support a means for receiving a bitmap that indicates a pattern of symbols of the slot, the pattern of symbols indicating a subset of symbols of the slot that are allocated for the ambient wireless device communications.

In some examples, to support receiving the indication of the TTI structure, the TTI structure component 925 is capable of, configured to, or operable to support a means for receiving a set of bits that indicates a pattern of time-frequency resources for the TTI structure, where the pattern of time-frequency resources is from a set of multiple patterns of time-frequency resources associated with the TTI structure.

In some examples, the TTI structure component 925 is capable of, configured to, or operable to support a means for receiving a second indication of a second TTI structure different from the TTI structure, the second TTI structure for a second slot allocated for the ambient wireless device communications. In some examples, the backscattered signaling component 940 is capable of, configured to, or operable to support a means for sending, in a third quantity of TTIs of the set of multiple TTIs, a second backscattered signal of the continuous waveform modulated with second data of the ambient wireless device, the third quantity of TTIs allocated for data from the ambient wireless device according to the second TTI structure.

In some examples, the TTI structure further indicates at least one TTI of the set of multiple TTIs allocated for a synchronization signal dedicated for ambient wireless device communications, and the synchronization component 955 is capable of, configured to, or operable to support a means for receiving, in accordance with the TTI structure, the synchronization signal in the at least one TTI of the set of multiple TTIs. In some examples, the TTI structure further indicates at least one TTI of the set of multiple TTIs allocated for a synchronization signal dedicated for ambient wireless device communications, and the synchronization component 955 is capable of, configured to, or operable to support a means for synchronizing with a wireless device using the synchronization signal.

In some examples, the subchannel component 960 is capable of, configured to, or operable to support a means for receiving, in a third quantity of TTIs of the set of multiple TTIs, a signal indicating one or more subchannels allocated for the set of multiple ambient wireless devices, where the backscattered signal is sent via the one or more subchannels.

In some examples, the subchannel component 960 is capable of, configured to, or operable to support a means for receiving, in a third quantity of TTIs of the set of multiple TTIs, a signal indicating the second TTI and a subchannel allocated for the ambient wireless device, where the backscattered signal is sent via the subchannel.

In some examples, the repetition component 965 is capable of, configured to, or operable to support a means for receiving, in a third quantity of TTIs of the set of multiple TTIs, a signal indicating a quantity of repetitions for the backscattered signal, where the backscattered signal is sent in accordance with the quantity of repetitions.

In some examples, the preference component 970 is capable of, configured to, or operable to support a means for sending an indication of a TTI structure preference based on the data of the ambient wireless device, an energy status of the ambient wireless device, or a combination thereof.

Additionally, or alternatively, the communications manager 920 may support wireless communication by a first wireless device in accordance with examples as disclosed herein. In some examples, the TTI structure component 925 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. In some examples, the TTI structure component 925 is capable of, configured to, or operable to support a means for transmitting, to an ambient wireless device of the set of multiple ambient wireless devices, the indication of the TTI structure. The backscattered signal reception component 945 is capable of, configured to, or operable to support a means for monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

In some examples, the frame structure component 950 is capable of, configured to, or operable to support a means for receiving, from the network entity, an indication of a frame structure for a set of slots including the slot, the frame structure indicating a respective communication direction for each slot of the set of slots, where a subset of slots of the set of slots is allocated for ambient wireless device communications. In some examples, the frame structure component 950 is capable of, configured to, or operable to support a means for transmitting, to the ambient wireless device, the indication of the frame structure for the set of slots.

In some examples, the frame structure component 950 is capable of, configured to, or operable to support a means for receiving a bitmap that indicates the subset of slots, where each slot of the set of slots is associated with a respective uplink or downlink communication direction in accordance with the frame structure. In some examples, the frame structure component 950 is capable of, configured to, or operable to support a means for transmitting the bitmap to the ambient wireless device.

In some examples, the frame structure component 950 is capable of, configured to, or operable to support a means for receiving a set of bits that indicates a pattern of time-frequency resources for the frame structure, where the pattern of time-frequency resources is from a set of multiple patterns of time-frequency resources associated with the frame structure. In some examples, the frame structure component 950 is capable of, configured to, or operable to support a means for transmitting the set of bits to the ambient wireless device.

In some examples, at least one slot of the set of slots is allocated for communications between the first wireless device and a second wireless device different from the first wireless device, and the forwarding component 975 is capable of, configured to, or operable to support a means for transmitting, to the second wireless device in the at least one slot, a message indicating the backscattered signal of the ambient wireless device or feedback information associated with the backscattered signal.

In some examples, to support receiving the indication of the TTI structure, the TTI structure component 925 is capable of, configured to, or operable to support a means for receiving a set of bits that indicates a pattern of time-frequency resources for the TTI structure, where the pattern of time-frequency resources is from a set of multiple patterns of time-frequency resources associated with the TTI structure. In some examples, to support receiving the indication of the TTI structure, the TTI structure component 925 is capable of, configured to, or operable to support a means for transmitting the set of bits to the ambient wireless device.

In some examples, to support receiving the indication of the TTI structure, the TTI structure component 925 is capable of, configured to, or operable to support a means for receiving the indication of the TTI structure that further indicates the first quantity of TTIs of the set of multiple TTIs that are allocated for backward link communications, a second quantity of TTIs of the set of multiple TTIs that are allocated for forward link data communications, and a third quantity of TTIs of the set of multiple TTIs that are allocated for continuous waveform communications, the third quantity of TTIs located prior to or subsequent to the first quantity of TTIs in a time domain, where at least one TTI of the third quantity of TTIs includes a guard interval between a first TTI of the first quantity of TTIs and a second TTI of the second quantity of TTIs.

In some examples, the TTI structure component 925 is capable of, configured to, or operable to support a means for receiving a second indication of a second TTI structure different from the TTI structure, the second TTI structure for a second slot allocated for the ambient wireless device communications. In some examples, the TTI structure component 925 is capable of, configured to, or operable to support a means for transmitting, to the ambient wireless device, the second indication of the second TTI structure. In some examples, the TTI structure component 925 is capable of, configured to, or operable to support a means for receiving, from the ambient wireless device in a third quantity of TTIs of the set of multiple TTIs, a second backscattered signal of the continuous waveform modulated with second data of the ambient wireless device, the third quantity of TTIs allocated for data from the ambient wireless device according to the second TTI structure.

In some examples, the TTI structure component 925 is capable of, configured to, or operable to support a means for transmitting, to a second wireless device, the indication of the TTI structure. In some examples, the TTI structure component 925 is capable of, configured to, or operable to support a means for receiving, from the second wireless device, an indication of a second TTI structure different from the TTI structure, the second TTI structure associated with the second wireless device and a second set of multiple ambient devices.

In some examples, the TTI structure component 925 is capable of, configured to, or operable to support a means for modifying the TTI structure based on the indication of the second TTI structure, a relative distance between the first wireless device and the second wireless device, or a combination thereof.

In some examples, the TTI structure further indicates at least one TTI of the set of multiple TTIs allocated for a synchronization signal dedicated for ambient wireless device communications, and the synchronization component 955 is capable of, configured to, or operable to support a means for receiving, from a second wireless device in accordance with the TTI structure, the synchronization signal in the at least one TTI of the set of multiple TTIs. In some examples, the TTI structure further indicates at least one TTI of the set of multiple TTIs allocated for a synchronization signal dedicated for ambient wireless device communications, and the synchronization component 955 is capable of, configured to, or operable to support a means for synchronizing with the second wireless device using the synchronization signal.

In some examples, the preference component 970 is capable of, configured to, or operable to support a means for receiving, from the ambient wireless device, an indication of a TTI structure preference based on the data of the ambient wireless device, an energy status of the ambient wireless device, or a combination thereof.

Additionally, or alternatively, the communications manager 920 may support wireless communication by a second wireless device in accordance with examples as disclosed herein. In some examples, the TTI structure component 925 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. In some examples, the TTI structure component 925 is capable of, configured to, or operable to support a means for transmitting, to an ambient wireless device of the set of multiple ambient wireless devices, the indication of the TTI structure. In some examples, the continuous waveform component 930 is capable of, configured to, or operable to support a means for transmitting, in a first quantity of TTIs of the set of multiple TTIs, a continuous waveform for the ambient wireless device, the first quantity of TTIs allocated for the continuous waveform according to the TTI structure.

In some examples, the frame structure component 950 is capable of, configured to, or operable to support a means for receiving, from the network entity, an indication of a frame structure for a set of slots including the slot, the frame structure indicating a respective communication direction for each slot of the set of slots, where a subset of slots of the set of slots is allocated for ambient wireless device communications. In some examples, the frame structure component 950 is capable of, configured to, or operable to support a means for transmitting, to the ambient wireless device, the indication of the frame structure for the set of slots.

In some examples, the frame structure component 950 is capable of, configured to, or operable to support a means for receiving a bitmap that indicates the subset of slots, where each slot of the set of slots is associated with a respective uplink or downlink communication direction in accordance with the frame structure.

In some examples, the frame structure component 950 is capable of, configured to, or operable to support a means for receiving a set of bits that indicates a pattern of time-frequency resources for the frame structure, where the pattern of time-frequency resources is from a set of multiple patterns of time-frequency resources associated with the frame structure.

In some examples, at least one slot of the set of slots is allocated for communications between the first wireless device and a second wireless device different from the first wireless device, and the forwarding component 975 is capable of, configured to, or operable to support a means for receiving, from the first wireless device in the at least one slot, a message indicating a backscattered signal of the ambient wireless device or feedback information associated with the backscattered signal.

In some examples, to support receiving the indication of the TTI structure, the TTI structure component 925 is capable of, configured to, or operable to support a means for receiving the indication of the TTI structure that further indicates the first quantity of TTIs of the set of multiple TTIs that are allocated for continuous wave communications, a second quantity of TTIs of the set of multiple TTIs that are allocated for forward link data communications, and a third quantity of TTIs of the set of multiple TTIs that are allocated for backward link data communications, where at least one TTI of the first quantity of TTIs includes a guard interval between a first TTI of the third quantity of TTIs and a second TTI of the second quantity of TTIs.

In some examples, to support receiving the indication of the TTI structure, the TTI structure component 925 is capable of, configured to, or operable to support a means for receiving a set of bits that indicates a pattern of time-frequency resources for the TTI structure, where the pattern of time-frequency resources is from a set of multiple patterns of time-frequency resources associated with the TTI structure.

In some examples, the TTI structure component 925 is capable of, configured to, or operable to support a means for receiving a second indication of a second TTI structure different from the TTI structure, the second TTI structure for a second slot allocated for ambient wireless device communications. In some examples, the TTI structure component 925 is capable of, configured to, or operable to support a means for transmitting, to the ambient wireless device, the second indication of the second TTI structure.

In some examples, the TTI structure component 925 is capable of, configured to, or operable to support a means for transmitting, to a first wireless device, an indication of the TTI structure. In some examples, the TTI structure component 925 is capable of, configured to, or operable to support a means for receiving, from the first wireless device, an indication of a second TTI structure different from the TTI structure, the second TTI structure associated with the first wireless device and a second set of multiple ambient devices.

In some examples, the TTI structure component 925 is capable of, configured to, or operable to support a means for modifying the TTI structure based on the indication of the second TTI structure, a relative distance between the first wireless device and the second wireless device, or a combination thereof.

In some examples, the TTI structure further indicates at least one TTI of the set of multiple TTIs allocated for a synchronization signal dedicated for ambient wireless device communications, and the synchronization component 955 is capable of, configured to, or operable to support a means for transmitting, to a first wireless device in accordance with the TTI structure, the synchronization signal in the at least one TTI of the set of multiple TTIs. In some examples, the TTI structure further indicates at least one TTI of the set of multiple TTIs allocated for a synchronization signal dedicated for ambient wireless device communications, and the synchronization component 955 is capable of, configured to, or operable to support a means for synchronizing with the first wireless device using the synchronization signal.

In some examples, the TTI structure indicates a second quantity of TTIs of the set of multiple TTIs allocated for a backscattered signal from the ambient wireless device, and the subchannel component 960 is capable of, configured to, or operable to support a means for transmitting, to the ambient wireless device in a third quantity of TTIs of the set of multiple TTIs, a signal indicating one or more subchannels allocated for the set of multiple ambient wireless devices.

In some examples, the TTI structure indicates a second quantity of TTIs of the set of multiple TTIs allocated for a backscattered signal from the ambient wireless device, and the repetition component 965 is capable of, configured to, or operable to support a means for transmitting, to the ambient wireless device in a third quantity of TTIs of the set of multiple TTIs, a signal indicating a quantity of repetitions for the backscattered signal.

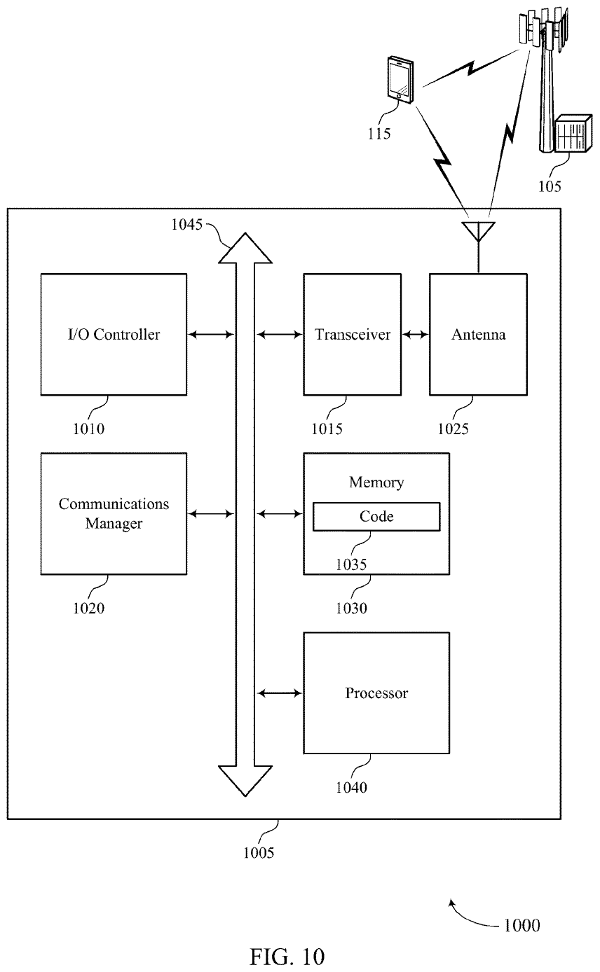

FIG. 10 shows a diagram of a system 1000 including a device 1005 that supports a TTI structure for ambient wireless device communications in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting TTI structure for ambient wireless device communications). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication by an ambient wireless device in accordance with examples as disclosed herein. For example, the communications manager 1020 is capable of, configured to, or operable to support a means for receiving an indication of a TTI structure for a slot allocated for ambient wireless device communications, the TTI structure indicating a set of multiple TTIs allocated for a set of multiple ambient wireless devices including the ambient wireless device. The communications manager 1020 is capable of, configured to, or operable to support a means for receiving, in a first quantity of TTIs of the set of multiple TTIs, a continuous waveform for the ambient wireless device, the first quantity of TTIs allocated for continuous waveform communications according to the TTI structure. The communications manager 1020 is capable of, configured to, or operable to support a means for modulating the continuous waveform with data of the ambient wireless device. The communications manager 1020 is capable of, configured to, or operable to support a means for sending, in a second quantity of TTIs of the set of multiple TTIs, a backscattered signal of the continuous waveform modulated with data of the ambient wireless device, the second quantity of TTIs allocated for data from the ambient wireless device according to the TTI structure.

Additionally, or alternatively, the communications manager 1020 may support wireless communication by a first wireless device in accordance with examples as disclosed herein. For example, the communications manager 1020 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The communications manager 1020 is capable of, configured to, or operable to support a means for transmitting, to an ambient wireless device of the set of multiple ambient wireless devices, the indication of the TTI structure. The communications manager 1020 is capable of, configured to, or operable to support a means for monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

Additionally, or alternatively, the communications manager 1020 may support wireless communication by a second wireless device in accordance with examples as disclosed herein. For example, the communications manager 1020 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The communications manager 1020 is capable of, configured to, or operable to support a means for transmitting, to an ambient wireless device of the set of multiple ambient wireless devices, the indication of the TTI structure. The communications manager 1020 is capable of, configured to, or operable to support a means for transmitting, in a first quantity of TTIs of the set of multiple TTIs, a continuous waveform for the ambient wireless device, the first quantity of TTIs allocated for the continuous waveform according to the TTI structure.

By including or configuring the communications manager 1020 in accordance with examples as described herein, the device 1005 may support techniques for communicating with ambient devices according to TTI structures. As such, the techniques described herein may enable the device 1005 to communicate with multiple ambient devices simultaneously, which may improve coordination between devices and reduce latency. Further, communicating with ambient devices according to a TTI structure may improve resource utilization efficiency.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of TTI structure for ambient wireless device communications as described herein, or the processor 1040 and the memory 1030 may be otherwise configured to perform or support such operations.

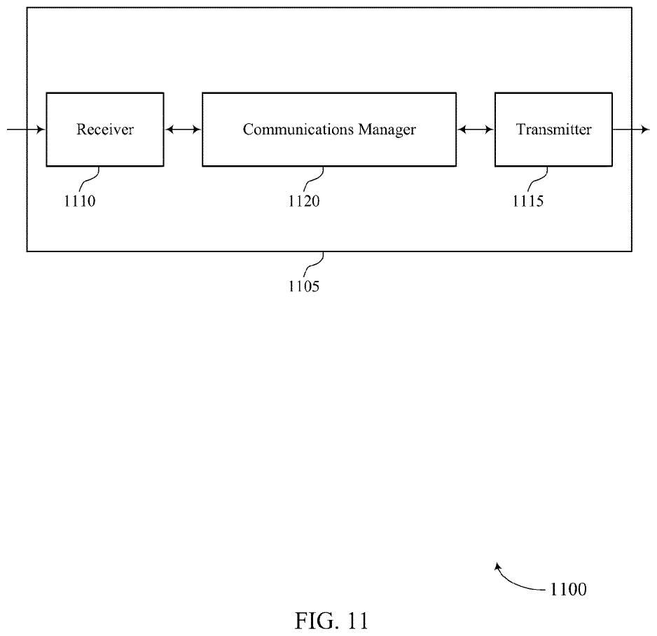

FIG. 11 shows a block diagram 1100 of a device 1105 that supports a TTI structure for ambient wireless device communications in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of TTI structure for ambient wireless device communications as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication by a first wireless device in accordance with examples as disclosed herein. For example, the communications manager 1120 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The communications manager 1120 is capable of, configured to, or operable to support a means for transmitting, to an ambient wireless device of the set of multiple ambient wireless devices, the indication of the TTI structure. The communications manager 1120 is capable of, configured to, or operable to support a means for monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

Additionally, or alternatively, the communications manager 1120 may support wireless communication by a second wireless device in accordance with examples as disclosed herein. For example, the communications manager 1120 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The communications manager 1120 is capable of, configured to, or operable to support a means for transmitting, to an ambient wireless device of the set of multiple ambient wireless devices, the indication of the TTI structure. The communications manager 1120 is capable of, configured to, or operable to support a means for transmitting, in a first quantity of TTIs of the set of multiple TTIs, a continuous waveform for the ambient wireless device, the first quantity of TTIs allocated for the continuous waveform according to the TTI structure.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for the use of TTI structures for communications with ambient devices. As such, the techniques described herein may enable the device 1105 to communicate with multiple ambient devices simultaneously, which may reduce processing and latency. Further, communicating with ambient devices according to a TTI structure may improve resource utilization efficiency.

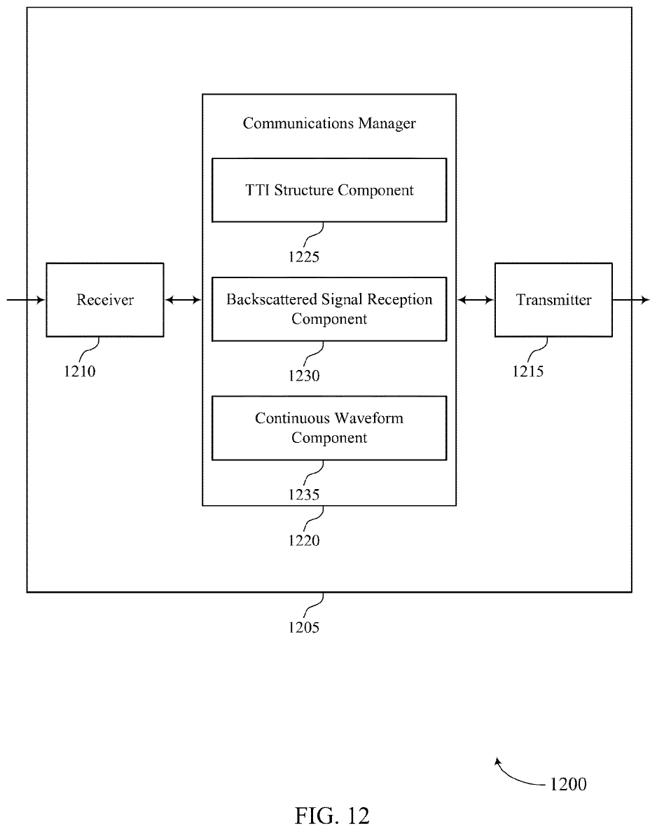

FIG. 12 shows a block diagram 1200 of a device 1205 that supports a TTI structure for ambient wireless device communications in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one of more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of TTI structure for ambient wireless device communications as described herein. For example, the communications manager 1220 may include a TTI structure component 1225, a backscattered signal reception component 1230, a continuous waveform component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication by a first wireless device in accordance with examples as disclosed herein. The TTI structure component 1225 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The TTI structure component 1225 is capable of, configured to, or operable to support a means for transmitting, to an ambient wireless device of the set of multiple ambient wireless devices, the indication of the TTI structure. The backscattered signal reception component 1230 is capable of, configured to, or operable to support a means for monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

Additionally, or alternatively, the communications manager 1220 may support wireless communication by a second wireless device in accordance with examples as disclosed herein. The TTI structure component 1225 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The TTI structure component 1225 is capable of, configured to, or operable to support a means for transmitting, to an ambient wireless device of the set of multiple ambient wireless devices, the indication of the TTI structure. The continuous waveform component 1235 is capable of, configured to, or operable to support a means for transmitting, in a first quantity of TTIs of the set of multiple TTIs, a continuous waveform for the ambient wireless device, the first quantity of TTIs allocated for the continuous waveform according to the TTI structure.

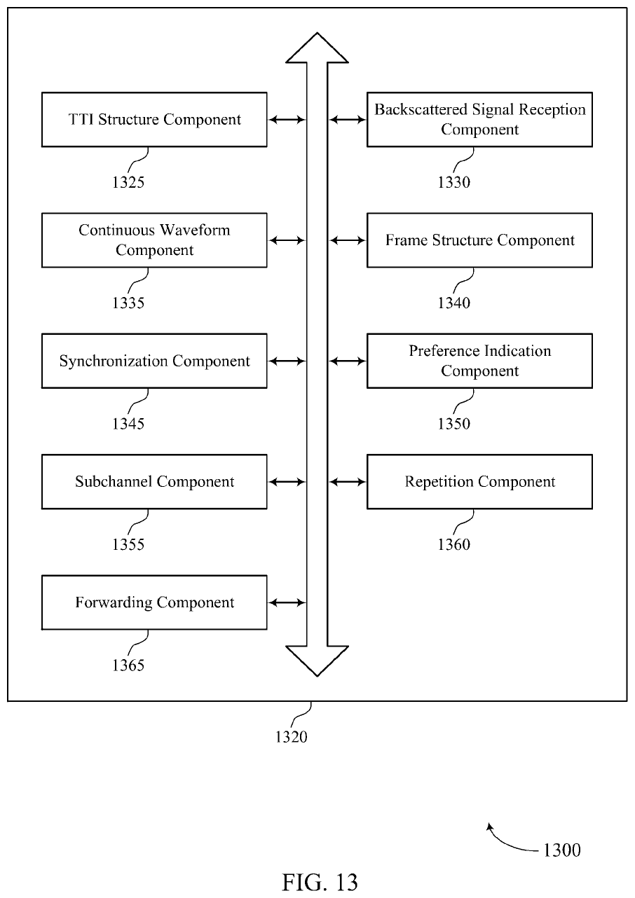

FIG. 13 shows a block diagram 1300 of a communications manager 1320 that supports a TTI structure for ambient wireless device communications in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of TTI structure for ambient wireless device communications as described herein. For example, the communications manager 1320 may include a TTI structure component 1325, a backscattered signal reception component 1330, a continuous waveform component 1335, a frame structure component 1340, a synchronization component 1345, a preference component 1350, a subchannel component 1355, a repetition component 1360, a forwarding component 1365, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication by a first wireless device in accordance with examples as disclosed herein. The TTI structure component 1325 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. In some examples, the TTI structure component 1325 is capable of, configured to, or operable to support a means for transmitting, to an ambient wireless device of the set of multiple ambient wireless devices, the indication of the TTI structure. The backscattered signal reception component 1330 is capable of, configured to, or operable to support a means for monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

In some examples, the frame structure component 1340 is capable of, configured to, or operable to support a means for receiving, from the network entity, an indication of a frame structure for a set of slots including the slot, the frame structure indicating a respective communication direction for each slot of the set of slots, where a subset of slots of the set of slots is allocated for ambient wireless device communications. In some examples, the frame structure component 1340 is capable of, configured to, or operable to support a means for transmitting, to the ambient wireless device, the indication of the frame structure for the set of slots.

In some examples, the frame structure component 1340 is capable of, configured to, or operable to support a means for receiving a bitmap that indicates the subset of slots, where each slot of the set of slots is associated with a respective uplink or downlink communication direction in accordance with the frame structure. In some examples, the frame structure component 1340 is capable of, configured to, or operable to support a means for transmitting the bitmap to the ambient wireless device.

In some examples, the frame structure component 1340 is capable of, configured to, or operable to support a means for receiving a set of bits that indicates a pattern of time-frequency resources for the frame structure, where the pattern of time-frequency resources is from a set of multiple patterns of time-frequency resources associated with the frame structure. In some examples, the frame structure component 1340 is capable of, configured to, or operable to support a means for transmitting the set of bits to the ambient wireless device.

In some examples, at least one slot of the set of slots is allocated for communications between the second wireless device and a first wireless device different from the second wireless device, and the forwarding component 1365 is capable of, configured to, or operable to support a means for transmitting, to the second wireless device in the at least one slot, a message indicating the backscattered signal of the ambient wireless device or feedback information associated with the backscattered signal.

In some examples, to support receiving the indication of the TTI structure, the TTI structure component 1325 is capable of, configured to, or operable to support a means for receiving a set of bits that indicates a pattern of time-frequency resources for the TTI structure, where the pattern of time-frequency resources is from a set of multiple patterns of time-frequency resources associated with the TTI structure. In some examples, to support receiving the indication of the TTI structure, the TTI structure component 1325 is capable of, configured to, or operable to support a means for transmitting the set of bits to the ambient wireless device.

In some examples, to support receiving the indication of the TTI structure, the TTI structure component 1325 is capable of, configured to, or operable to support a means for receiving the indication of the TTI structure that further indicates the first quantity of TTIs of the set of multiple TTIs that are allocated for backward link communications, a second quantity of TTIs of the set of multiple TTIs that are allocated for forward link data communications, and a third quantity of TTIs of the set of multiple TTIs that are allocated for continuous waveform communications, the third quantity of TTIs located prior to or subsequent to the first quantity of TTIs in a time domain, where at least one TTI of the third quantity of TTIs includes a guard interval between a first TTI of the first quantity of TTIs and a second TTI of the second quantity of TTIs.

In some examples, the TTI structure component 1325 is capable of, configured to, or operable to support a means for receiving a second indication of a second TTI structure different from the TTI structure, the second TTI structure for a second slot allocated for the ambient wireless device communications. In some examples, the TTI structure component 1325 is capable of, configured to, or operable to support a means for transmitting, to the ambient wireless device, the second indication of the second TTI structure. In some examples, the TTI structure component 1325 is capable of, configured to, or operable to support a means for receiving, from the ambient wireless device in a third quantity of TTIs of the set of multiple TTIs, a second backscattered signal of the continuous waveform modulated with second data of the ambient wireless device, the third quantity of TTIs allocated for data from the ambient wireless device according to the second TTI structure.

In some examples, the TTI structure component 1325 is capable of, configured to, or operable to support a means for transmitting, to a second wireless device, the indication of the TTI structure. In some examples, the TTI structure component 1325 is capable of, configured to, or operable to support a means for receiving, from the second wireless device, an indication of a second TTI structure different from the TTI structure, the second TTI structure associated with the second wireless device and a second set of multiple ambient devices.

In some examples, the TTI structure component 1325 is capable of, configured to, or operable to support a means for modifying the TTI structure based on the indication of the second TTI structure, a relative distance between the first wireless device and the second wireless device, or a combination thereof.

In some examples, the TTI structure further indicates at least one TTI of the set of multiple TTIs allocated for a synchronization signal dedicated for ambient wireless device communications, and the synchronization component 1345 is capable of, configured to, or operable to support a means for receiving, from a second wireless device in accordance with the TTI structure, the synchronization signal in the at least one TTI of the set of multiple TTIs. In some examples, the TTI structure further indicates at least one TTI of the set of multiple TTIs allocated for a synchronization signal dedicated for ambient wireless device communications, and the synchronization component 1345 is capable of, configured to, or operable to support a means for synchronizing with the second wireless device using the synchronization signal.

In some examples, the preference component 1350 is capable of, configured to, or operable to support a means for receiving, from the ambient wireless device, an indication of a TTI structure preference based on the data of the ambient wireless device, an energy status of the ambient wireless device, or a combination thereof.

Additionally, or alternatively, the communications manager 1320 may support wireless communication by a second wireless device in accordance with examples as disclosed herein. In some examples, the TTI structure component 1325 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. In some examples, the TTI structure component 1325 is capable of, configured to, or operable to support a means for transmitting, to an ambient wireless device of the set of multiple ambient wireless devices, the indication of the TTI structure. The continuous waveform component 1335 is capable of, configured to, or operable to support a means for transmitting, in a first quantity of TTIs of the set of multiple TTIs, a continuous waveform for the ambient wireless device, the first quantity of TTIs allocated for the continuous waveform according to the TTI structure.

In some examples, the frame structure component 1340 is capable of, configured to, or operable to support a means for receiving, from the network entity, an indication of a frame structure for a set of slots including the slot, the frame structure indicating a respective communication direction for each slot of the set of slots, where a subset of slots of the set of slots is allocated for ambient wireless device communications. In some examples, the frame structure component 1340 is capable of, configured to, or operable to support a means for transmitting, to the ambient wireless device, the indication of the frame structure for the set of slots.

In some examples, the frame structure component 1340 is capable of, configured to, or operable to support a means for receiving a bitmap that indicates the subset of slots, where each slot of the set of slots is associated with a respective uplink or downlink communication direction in accordance with the frame structure.

In some examples, the frame structure component 1340 is capable of, configured to, or operable to support a means for receiving a set of bits that indicates a pattern of time-frequency resources for the frame structure, where the pattern of time-frequency resources is from a set of multiple patterns of time-frequency resources associated with the frame structure.

In some examples, at least one slot of the set of slots is allocated for communications between the second wireless device and a first wireless device different from the second wireless device, and the forwarding component 1365 is capable of, configured to, or operable to support a means for receiving, from the first wireless device in the at least one slot, a message indicating a backscattered signal of the ambient wireless device or feedback information associated with the backscattered signal.

In some examples, to support receiving the indication of the TTI structure, the TTI structure component 1325 is capable of, configured to, or operable to support a means for receiving the indication of the TTI structure that further indicates the first quantity of TTIs of the set of multiple TTIs that are allocated for continuous wave communications, a second quantity of TTIs of the set of multiple TTIs that are allocated for forward link data communications, and a third quantity of TTIs of the set of multiple TTIs that are allocated for backward link data communications, where at least one TTI of the first quantity of TTIs includes a guard interval between a first TTI of the third quantity of TTIs and a second TTI of the second quantity of TTIs.

In some examples, to support receiving the indication of the TTI structure, the TTI structure component 1325 is capable of, configured to, or operable to support a means for receiving a set of bits that indicates a pattern of time-frequency resources for the TTI structure, where the pattern of time-frequency resources is from a set of multiple patterns of time-frequency resources associated with the TTI structure.

In some examples, the TTI structure component 1325 is capable of, configured to, or operable to support a means for receiving a second indication of a second TTI structure different from the TTI structure, the second TTI structure for a second slot allocated for ambient wireless device communications. In some examples, the TTI structure component 1325 is capable of, configured to, or operable to support a means for transmitting, to the ambient wireless device, the second indication of the second TTI structure.

In some examples, the TTI structure component 1325 is capable of, configured to, or operable to support a means for transmitting, to a first wireless device, an indication of the TTI structure. In some examples, the TTI structure component 1325 is capable of, configured to, or operable to support a means for receiving, from the first wireless device, an indication of a second TTI structure different from the TTI structure, the second TTI structure associated with the first wireless device and a second set of multiple ambient devices.

In some examples, the TTI structure component 1325 is capable of, configured to, or operable to support a means for modifying the TTI structure based on the indication of the second TTI structure, a relative distance between the first wireless device and the second wireless device, or a combination thereof.

In some examples, the TTI structure further indicates at least one TTI of the set of multiple TTIs allocated for a synchronization signal dedicated for ambient wireless device communications, and the synchronization component 1345 is capable of, configured to, or operable to support a means for transmitting, to a first wireless device in accordance with the TTI structure, the synchronization signal in the at least one TTI of the set of multiple TTIs. In some examples, the TTI structure further indicates at least one TTI of the set of multiple TTIs allocated for a synchronization signal dedicated for ambient wireless device communications, and the synchronization component 1345 is capable of, configured to, or operable to support a means for synchronizing with the first wireless device using the synchronization signal.

In some examples, the TTI structure indicates a second quantity of TTIs of the set of multiple TTIs allocated for a backscattered signal from the ambient wireless device, and the subchannel component 1355 is capable of, configured to, or operable to support a means for transmitting, to the ambient wireless device in a third quantity of TTIs of the set of multiple TTIs, a signal indicating one or more subchannels allocated for the set of multiple ambient wireless devices.

In some examples, the TTI structure indicates a second quantity of TTIs of the set of multiple TTIs allocated for a backscattered signal from the ambient wireless device, and the repetition component 1360 is capable of, configured to, or operable to support a means for transmitting, to the ambient wireless device in a third quantity of TTIs of the set of multiple TTIs, a signal indicating a quantity of repetitions for the backscattered signal.

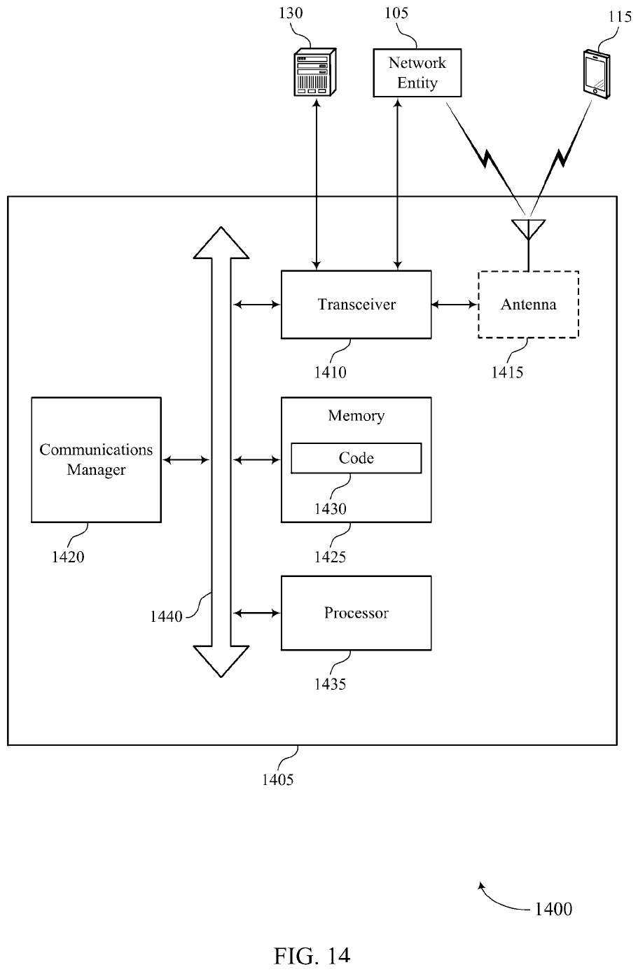

FIG. 14 shows a diagram of a system 1400 including a device 1405 that supports a TTI structure for ambient wireless device communications in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting TTI structure for ambient wireless device communications). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication by a first wireless device in accordance with examples as disclosed herein. For example, the communications manager 1420 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The communications manager 1420 is capable of, configured to, or operable to support a means for transmitting, to an ambient wireless device of the set of multiple ambient wireless devices, the indication of the TTI structure. The communications manager 1420 is capable of, configured to, or operable to support a means for monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure.

Additionally, or alternatively, the communications manager 1420 may support wireless communication by a second wireless device in accordance with examples as disclosed herein. For example, the communications manager 1420 is capable of, configured to, or operable to support a means for receiving, from a network entity, an indication of a TTI structure for a slot allocated for ambient wireless device communications, the TTI structure indicating a set of multiple TTIs allocated for a set of multiple ambient wireless devices. The communications manager 1420 is capable of, configured to, or operable to support a means for transmitting, to an ambient wireless device of the set of multiple ambient wireless devices, the indication of the TTI structure. The communications manager 1420 is capable of, configured to, or operable to support a means for transmitting, in a first quantity of TTIs of the set of multiple TTIs, a continuous waveform for the ambient wireless device, the first quantity of TTIs allocated for the continuous waveform according to the TTI structure.

By including or configuring the communications manager 1420 in accordance with examples as described herein, the device 1405 may support techniques for communicating with ambient devices according to TTI structures. As such, the techniques described herein may enable the device 1405 to communicate with multiple ambient devices simultaneously, which may improve coordination between devices and reduce latency. Further, communicating with ambient devices according to a TTI structure may improve resource utilization efficiency.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of TTI structure for ambient wireless device communications as described herein, or the processor 1435 and the memory 1425 may be otherwise configured to perform or support such operations.

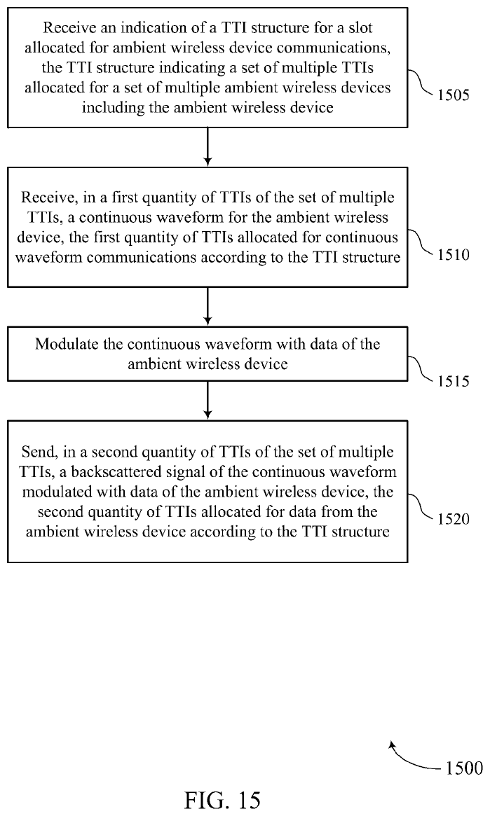

FIG. 15 shows a flowchart illustrating a method 1500 that supports a TTI structure for ambient wireless device communications in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a TTI structure for a slot allocated for ambient wireless device communications, the TTI structure indicating a set of multiple TTIs allocated for a set of multiple ambient wireless devices including the ambient wireless device. The operations of block 1505 may be performed in accordance with examples as disclosed herein. In some examples, aspects of the operations of 1505 may be performed by a TTI structure component 925 as described with reference to FIG. 9.

At 1510, the method may include receiving, in a first quantity of TTIs of the set of multiple TTIs, a continuous waveform for the ambient wireless device, the first quantity of TTIs allocated for continuous waveform communications according to the TTI structure. The operations of block 1510 may be performed in accordance with examples as disclosed herein. In some examples, aspects of the operations of 1510 may be performed by a continuous waveform component 930 as described with reference to FIG. 9.

At 1515, the method may include modulating the continuous waveform with data of the ambient wireless device. The operations of block 1515 may be performed in accordance with examples as disclosed herein. In some examples, aspects of the operations of 1515 may be performed by a waveform modulation component 935 as described with reference to FIG. 9.

At 1520, the method may include sending, in a second quantity of TTIs of the set of multiple TTIs, a backscattered signal of the continuous waveform modulated with data of the ambient wireless device, the second quantity of TTIs allocated for data from the ambient wireless device according to the TTI structure. The operations of block 1520 may be performed in accordance with examples as disclosed herein. In some examples, aspects of the operations of 1520 may be performed by a backscattered signaling component 940 as described with reference to FIG. 9.

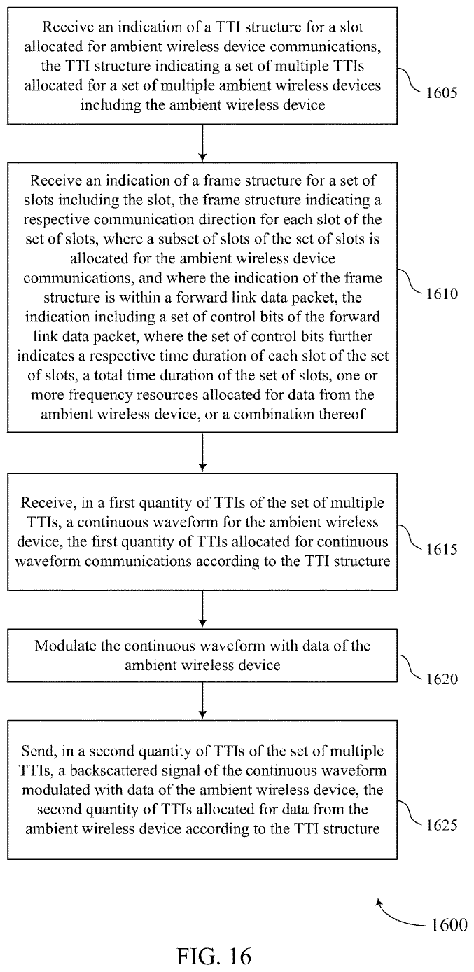

FIG. 16 shows a flowchart illustrating a method 1600 that supports a TTI structure for ambient wireless device communications in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving an indication of a TTI structure for a slot allocated for ambient wireless device communications, the TTI structure indicating a set of multiple TTIs allocated for a set of multiple ambient wireless devices including the ambient wireless device. The operations of block 1605 may be performed in accordance with examples as disclosed herein. In some examples, aspects of the operations of 1605 may be performed by a TTI structure component 925 as described with reference to FIG. 9.

At 1610, the method may include receiving an indication of a frame structure for a set of slots including the slot, the frame structure indicating a respective communication direction for each slot of the set of slots, where a subset of slots of the set of slots is allocated for the ambient wireless device communications, and where the indication of the frame structure is within a forward link data packet, the indication including a set of control bits of the forward link data packet, where the set of control bits further indicates a respective time duration of each slot of the set of slots, a total time duration of the set of slots, one or more frequency resources allocated for data from the ambient wireless device, or a combination thereof. The operations of block 1610 may be performed in accordance with examples as disclosed herein. In some examples, aspects of the operations of 1610 may be performed by a frame structure component 950 as described with reference to FIG. 9.

At 1615, the method may include receiving, in a first quantity of TTIs of the set of multiple TTIs, a continuous waveform for the ambient wireless device, the first quantity of TTIs allocated for continuous waveform communications according to the TTI structure. The operations of block 1615 may be performed in accordance with examples as disclosed herein. In some examples, aspects of the operations of 1615 may be performed by a continuous waveform component 930 as described with reference to FIG. 9.

At 1620, the method may include modulating the continuous waveform with data of the ambient wireless device. The operations of block 1620 may be performed in accordance with examples as disclosed herein. In some examples, aspects of the operations of 1620 may be performed by a waveform modulation component 935 as described with reference to FIG. 9.

At 1625, the method may include sending, in a second quantity of TTIs of the set of multiple TTIs, a backscattered signal of the continuous waveform modulated with data of the ambient wireless device, the second quantity of TTIs allocated for data from the ambient wireless device according to the TTI structure. The operations of block 1625 may be performed in accordance with examples as disclosed herein. In some examples, aspects of the operations of 1625 may be performed by a backscattered signaling component 940 as described with reference to FIG. 9.

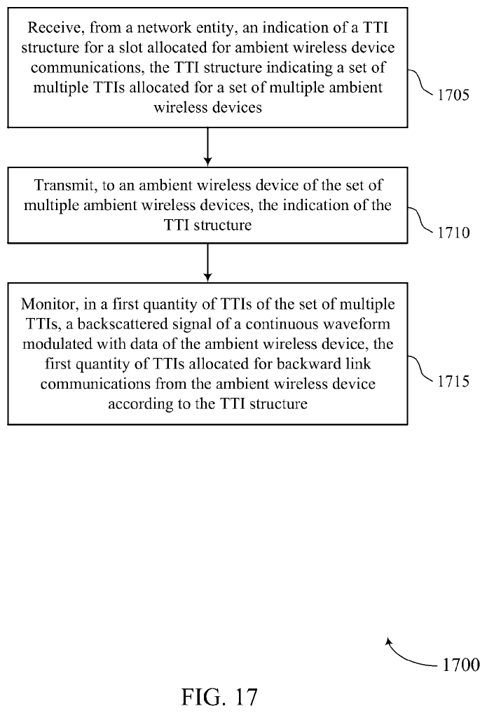

FIG. 17 shows a flowchart illustrating a method 1700 that supports a TTI structure for ambient wireless device communications in accordance with aspects of the present disclosure. The operations of the method 1700 may be implemented by a UE or a network entity or its components as described herein. For example, the operations of the method 1700 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include receiving, from a network entity, an indication of a TTI structure for a slot allocated for ambient wireless device communications, the TTI structure indicating a set of multiple TTIs allocated for a set of multiple ambient wireless devices. The operations of block 1705 may be performed in accordance with examples as disclosed herein. In some examples, aspects of the operations of 1705 may be performed by a TTI structure component 925 or a TTI structure component 1325 as described with reference to FIGS. 9 and 13.

At 1710, the method may include transmitting, to an ambient wireless device of the set of multiple ambient wireless devices, the indication of the TTI structure. The operations of block 1710 may be performed in accordance with examples as disclosed herein. In some examples, aspects of the operations of 1710 may be performed by a TTI structure component 925 or a TTI structure component 1325 as described with reference to FIGS. 9 and 13.

At 1715, the method may include monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure. The operations of block 1715 may be performed in accordance with examples as disclosed herein. In some examples, aspects of the operations of 1715 may be performed by a backscattered signal reception component 945 or a backscattered signal reception component 1330 as described with reference to FIGS. 9 and 13.

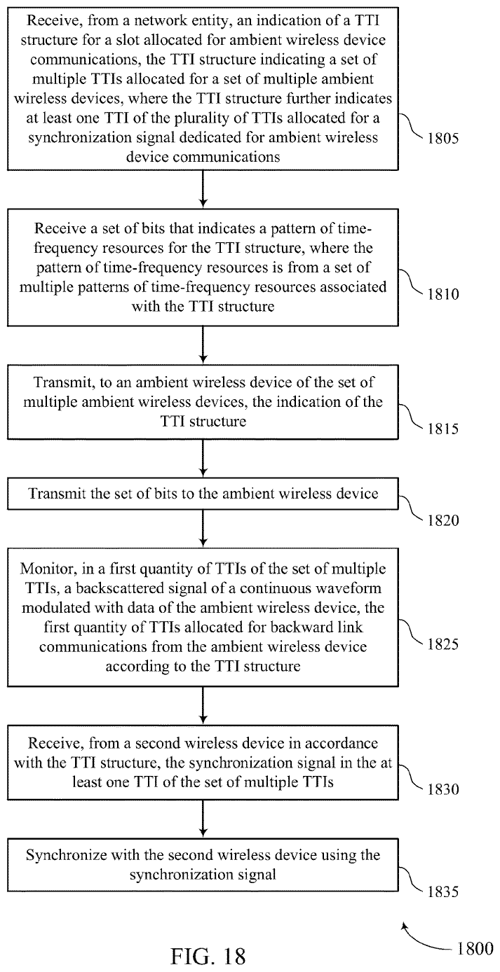

FIG. 18 shows a flowchart illustrating a method 1800 that supports a TTI structure for ambient wireless device communications in accordance with aspects of the present disclosure. The operations of the method 1800 may be implemented by a UE or a network entity or its components as described herein. For example, the operations of the method 1800 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include receiving, from a network entity, an indication of a TTI structure for a slot allocated for ambient wireless device communications, the TTI structure indicating a set of multiple TTIs allocated for a set of multiple ambient wireless devices, where the TTI structure further indicates at least one TTI of the plurality of TTIs allocated for a synchronization signal dedicated for ambient wireless device communications. The operations of block 1805 may be performed in accordance with examples as disclosed herein. In some examples, aspects of the operations of 1805 may be performed by a TTI structure component 925 or a TTI structure component 1325 as described with reference to FIGS. 9 and 13.

At 1810, the method may include receiving a set of bits that indicates a pattern of time-frequency resources for the TTI structure, where the pattern of time-frequency resources is from a set of multiple patterns of time-frequency resources associated with the TTI structure. The operations of block 1810 may be performed in accordance with examples as disclosed herein. In some examples, aspects of the operations of 1810 may be performed by a TTI structure component 925 or a TTI structure component 1325 as described with reference to FIGS. 9 and 13.

At 1815, the method may include transmitting, to an ambient wireless device of the set of multiple ambient wireless devices, the indication of the TTI structure. The operations of block 1815 may be performed in accordance with examples as disclosed herein. In some examples, aspects of the operations of 1815 may be performed by a TTI structure component 925 or a TTI structure component 1325 as described with reference to FIGS. 9 and 13.

At 1820, the method may include transmitting the set of bits to the ambient wireless device. The operations of block 1820 may be performed in accordance with examples as disclosed herein. In some examples, aspects of the operations of 1820 may be performed by a TTI structure component 925 or a TTI structure component 1325 as described with reference to FIGS. 9 and 13.

At 1825, the method may include monitoring, in a first quantity of TTIs of the set of multiple TTIs, a backscattered signal of a continuous waveform modulated with data of the ambient wireless device, the first quantity of TTIs allocated for backward link communications from the ambient wireless device according to the TTI structure. The operations of block 1825 may be performed in accordance with examples as disclosed herein. In some examples, aspects of the operations of 1825 may be performed by a backscattered signal reception component 945 or a backscattered signal reception component 1330 as described with reference to FIGS. 9 and 13.

At 1830, the method may include receiving, from a second wireless device in accordance with the TTI structure, the synchronization signal in the at least one TTI of the set of multiple TTIs. The operations of block 1830 may be performed in accordance with examples as disclosed herein. In some examples, aspects of the operations of 1830 may be performed by a synchronization component 955 or a synchronization component 1345 as described with reference to FIGS. 9 and 13.

At 1835, the method may include synchronizing with the second wireless device using the synchronization signal. The operations of block 1835 may be performed in accordance with examples as disclosed herein. In some examples, aspects of the operations of 1835 may be performed by a synchronization component 955 or a synchronization component 1345 as described with reference to FIGS. 9 and 13.

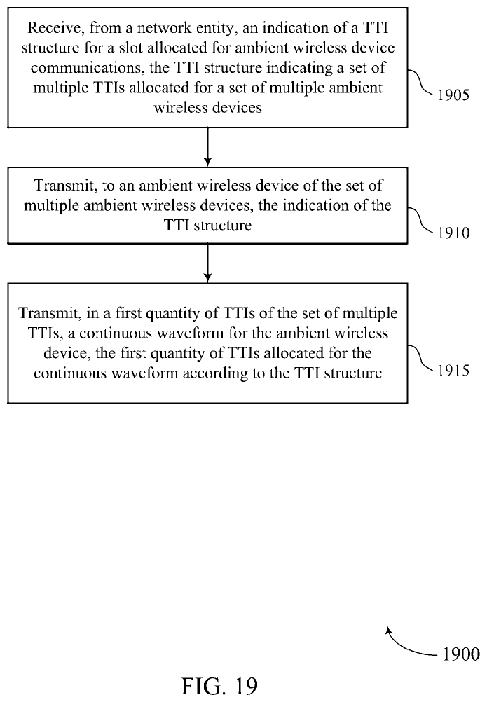

FIG. 19 shows a flowchart illustrating a method 1900 that supports a TTI structure for ambient wireless device communications in accordance with aspects of the present disclosure. The operations of the method 1900 may be implemented by a UE or a network entity or its components as described herein. For example, the operations of the method 1900 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include receiving, from a network entity, an indication of a TTI structure for a slot allocated for ambient wireless device communications, the TTI structure indicating a set of multiple TTIs allocated for a set of multiple ambient wireless devices. The operations of block 1905 may be performed in accordance with examples as disclosed herein. In some examples, aspects of the operations of 1905 may be performed by a TTI structure component 925 or a TTI structure component 1325 as described with reference to FIGS. 9 and 13.

At 1910, the method may include transmitting, to an ambient wireless device of the set of multiple ambient wireless devices, the indication of the TTI structure. The operations of block 1910 may be performed in accordance with examples as disclosed herein. In some examples, aspects of the operations of 1910 may be performed by a TTI structure component 925 or a TTI structure component 1325 as described with reference to FIGS. 9 and 13.

At 1915, the method may include transmitting, in a first quantity of TTIs of the set of multiple TTIs, a continuous waveform for the ambient wireless device, the first quantity of TTIs allocated for the continuous waveform according to the TTI structure. The operations of block 1915 may be performed in accordance with examples as disclosed herein. In some examples, aspects of the operations of 1915 may be performed by a continuous waveform component 930 or a continuous waveform component 1335 as described with reference to FIGS. 9 and 13.

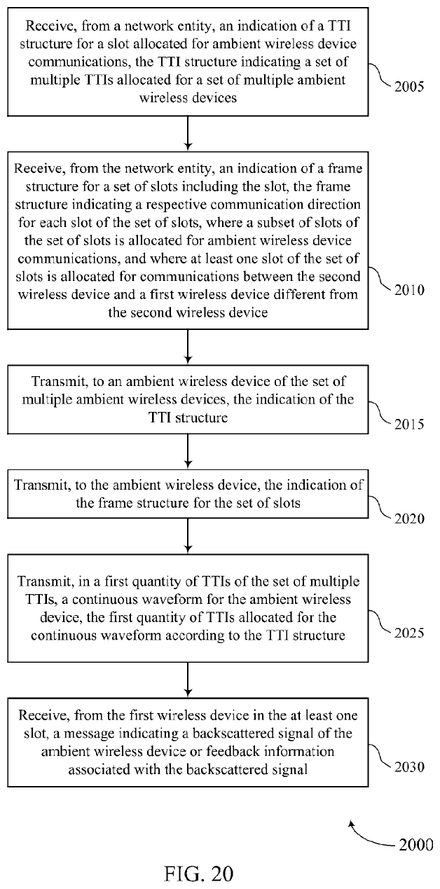

FIG. 20 shows a flowchart illustrating a method 2000 that supports a TTI structure for ambient wireless device communications in accordance with aspects of the present disclosure. The operations of the method 2000 may be implemented by a UE or a network entity or its components as described herein. For example, the operations of the method 2000 may be performed by a UE 115 as described with reference to FIGS. 1 through 10 or a network entity as described with reference to FIGS. 1 through 6 and 11 through 14. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 2005, the method may include receiving, from a network entity, an indication of a TTI structure for a slot allocated for ambient wireless device communications, the TTI structure indicating a set of multiple TTIs allocated for a set of multiple ambient wireless devices. The operations of block 2005 may be performed in accordance with examples as disclosed herein. In some examples, aspects of the operations of 2005 may be performed by a TTI structure component 925 or a TTI structure component 1325 as described with reference to FIGS. 9 and 13.

At 2010, the method may include receiving, from the network entity, an indication of a frame structure for a set of slots including the slot, the frame structure indicating a respective communication direction for each slot of the set of slots, where a subset of slots of the set of slots is allocated for ambient wireless device communications, and where at least one slot of the set of slots is allocated for communications between the second wireless device and a first wireless device different from the second wireless device. The operations of block 2010 may be performed in accordance with examples as disclosed herein. In some examples, aspects of the operations of 2010 may be performed by a frame structure component 950 or a frame structure component 1340 as described with reference to FIGS. 9 and 13.

At 2015, the method may include transmitting, to an ambient wireless device of the set of multiple ambient wireless devices, the indication of the TTI structure. The operations of block 2015 may be performed in accordance with examples as disclosed herein. In some examples, aspects of the operations of 2015 may be performed by a TTI structure component 925 or a TTI structure component 1325 as described with reference to FIGS. 9 and 13.

At 2020, the method may include transmitting, to the ambient wireless device, the indication of the frame structure for the set of slots. The operations of block 2020 may be performed in accordance with examples as disclosed herein. In some examples, aspects of the operations of 2020 may be performed by a frame structure component 950 or a frame structure component 1340 as described with reference to FIGS. 9 and 13.

At 2025, the method may include transmitting, in a first quantity of TTIs of the set of multiple TTIs, a continuous waveform for the ambient wireless device, the first quantity of TTIs allocated for the continuous waveform according to the TTI structure. The operations of block 2025 may be performed in accordance with examples as disclosed herein. In some examples, aspects of the operations of 2025 may be performed by a continuous waveform component 930 or a continuous waveform component 1335 as described with reference to FIGS. 9 and 13.

At 2030, the method may include receiving, from the first wireless device in the at least one slot, a message indicating a backscattered signal of the ambient wireless device or feedback information associated with the backscattered signal. The operations of block 2030 may be performed in accordance with examples as disclosed herein. In some examples, aspects of the operations of 2030 may be performed by a forwarding component 975 or a forwarding component 1365 as described with reference to FIGS. 9 and 13.

The following provides an overview of aspects of the present disclosure:
Aspect 1: A method for wireless communication by an ambient wireless device, comprising: receiving an indication of a TTI structure for a slot allocated for ambient wireless device communications, the TTI structure indicating a plurality of TTIs allocated for a plurality of ambient wireless devices including the ambient wireless device; receiving, in a first quantity of TTIs of the plurality of TTIs, a continuous waveform for the ambient wireless device, the first quantity of TTIs allocated for continuous waveform communications according to the TTI structure; modulating the continuous waveform with data of the ambient wireless device; and sending, in a second quantity of TTIs of the plurality of TTIs, a backscattered signal of the continuous waveform modulated with data of the ambient wireless device, the second quantity of TTIs allocated for data from the ambient wireless device according to the TTI structure.
Aspect 2: The method of aspect 1, further comprising: receiving an indication of a frame structure for a set of slots including the slot, the frame structure indicating a respective communication direction for each slot of the set of slots, wherein a subset of slots of the set of slots is allocated for the ambient wireless device communications.
Aspect 3: The method of aspect 2, wherein receiving the indication of the frame structure comprises: receiving the indication of the frame structure within a forward link data packet, the indication comprising a set of control bits of the forward link data packet, wherein the set of control bits further indicates a respective time duration of each slot of the set of slots, a total time duration of the set of slots, one or more frequency resources allocated for data from the ambient wireless device, or a combination thereof.
Aspect 4: The method of any of aspects 2 through 3, further comprising: receiving a bitmap that indicates the subset of slots, wherein each slot of the set of slots is associated with a respective uplink or downlink communication direction in accordance with the frame structure.
Aspect 5: The method of any of aspects 2 through 4, further comprising: receiving a set of bits that indicates a pattern of time-frequency resources for the frame structure, wherein the pattern of time-frequency resources is from a plurality of patterns of time-frequency resources associated with the frame structure.
Aspect 6: The method of any of aspects 1 through 5, wherein receiving the indication of the TTI structure comprises: receiving the indication of the TTI structure that further indicates the first quantity of TTIs of the plurality of TTIs that are allocated for continuous wave communications, the second quantity of TTIs of the plurality of TTIs that are allocated for backward link data communications, and a third quantity of TTIs of the plurality of TTIs that are allocated for forward link data communications, the first quantity of TTIs located prior to or subsequent to the second quantity of TTIs in a time domain, wherein at least one TTI of the first quantity of TTIs comprises a guard interval between a first TTI of the third quantity of TTIs and a second TTI of the second quantity of TTIs.
Aspect 7: The method of any of aspects 1 through 6, wherein receiving the indication of the TTI structure comprises: receiving a bitmap that indicates a pattern of symbols of the slot, the pattern of symbols indicating a subset of symbols of the slot that are allocated for the ambient wireless device communications.
Aspect 8: The method of any of aspects 1 through 7, wherein receiving the indication of the TTI structure comprises: receiving a set of bits that indicates a pattern of time-frequency resources for the TTI structure, wherein the pattern of time-frequency resources is from a plurality of patterns of time-frequency resources associated with the TTI structure.
Aspect 9: The method of any of aspects 1 through 8, further comprising: receiving a second indication of a second TTI structure different from the TTI structure, the second TTI structure for a second slot allocated for the ambient wireless device communications; and sending, in a third quantity of TTIs of the plurality of TTIs, a second backscattered signal of the continuous waveform modulated with second data of the ambient wireless device, the third quantity of TTIs allocated for data from the ambient wireless device according to the second TTI structure.
Aspect 10: The method of any of aspects 1 through 9, wherein the TTI structure further indicates at least one TTI of the plurality of TTIs allocated for a synchronization signal dedicated for ambient wireless device communications, the method further comprising: receiving, in accordance with the TTI structure, the synchronization signal in the at least one TTI of the plurality of TTIs; and synchronizing with a wireless device using the synchronization signal.
Aspect 11: The method of any of aspects 1 through 10, further comprising: receiving, in a third quantity of TTIs of the plurality of TTIs, a signal indicating one or more subchannels allocated for the plurality of ambient wireless devices, wherein the backscattered signal is sent via the one or more subchannels.
Aspect 12: The method of any of aspects 1 through 11, further comprising: receiving, in a third quantity of TTIs of the plurality of TTIs, a signal indicating the second TTI and a subchannel allocated for the ambient wireless device, wherein the backscattered signal is sent via the subchannel.
Aspect 13: The method of any of aspects 1 through 12, further comprising: receiving, in a third quantity of TTIs of the plurality of TTIs, a signal indicating a quantity of repetitions for the backscattered signal, wherein the backscattered signal is sent in accordance with the quantity of repetitions.
Aspect 14: The method of any of aspects 1 through 13, further comprising: sending an indication of a TTI structure preference based at least in part on the data of the ambient wireless device, an energy status of the ambient wireless device, or a combination thereof.
Aspect 15: A method for wireless communication by a first wireless device, comprising: receiving, from a network entity, an indication of a TTI structure for a slot allocated for ambient wireless device communications, the TTI structure indicating a plurality of TTIs allocated for a plurality of ambient wireless devices; transmitting, to an ambient wireless device of the plurality of ambient wireless devices, the indication of the TTI structure; and monitoring, in a first quantity of TTIs of the plurality of TTIs, a backscattered signal of a continuous waveform modulated with data of the ambient wireless device, the first quantity of TTIs allocated for backward link communications from the ambient wireless device according to the TTI structure.
Aspect 16: The method of aspect 15, further comprising: receiving, from the network entity, an indication of a frame structure for a set of slots including the slot, the frame structure indicating a respective communication direction for each slot of the set of slots, wherein a subset of slots of the set of slots is allocated for ambient wireless device communications; and transmitting, to the ambient wireless device, the indication of the frame structure for the set of slots.
Aspect 17: The method of aspect 16, further comprising: receiving a bitmap that indicates the subset of slots, wherein each slot of the set of slots is associated with a respective uplink or downlink communication direction in accordance with the frame structure; and transmitting the bitmap to the ambient wireless device.
Aspect 18: The method of any of aspects 16 through 17, further comprising: receiving a set of bits that indicates a pattern of time-frequency resources for the frame structure, wherein the pattern of time-frequency resources is from a plurality of patterns of time-frequency resources associated with the frame structure; and transmitting the set of bits to the ambient wireless device.
Aspect 19: The method of any of aspects 16 through 18, wherein at least one slot of the set of slots is allocated for communications between the first wireless device and a second wireless device different from the first wireless device, the method further comprising: transmitting, to the second wireless device in the at least one slot, a message indicating the backscattered signal of the ambient wireless device or feedback information associated with the backscattered signal.
Aspect 20: The method of any of aspects 15 through 19, wherein receiving the indication of the TTI structure comprises: receiving a set of bits that indicates a pattern of time-frequency resources for the TTI structure, wherein the pattern of time-frequency resources is from a plurality of patterns of time-frequency resources associated with the TTI structure; and transmitting the set of bits to the ambient wireless device.
Aspect 21: The method of any of aspects 15 through 20, wherein receiving the indication of the TTI structure comprises: receiving the indication of the TTI structure that further indicates the first quantity of TTIs of the plurality of TTIs that are allocated for backward link communications, a second quantity of TTIs of the plurality of TTIs that are allocated for forward link data communications, and a third quantity of TTIs of the plurality of TTIs that are allocated for continuous waveform communications, the third quantity of TTIs located prior to or subsequent to the first quantity of TTIs in a time domain, wherein at least one TTI of the third quantity of TTIs comprises a guard interval between a first TTI of the first quantity of TTIs and a second TTI of the second quantity of TTIs.
Aspect 22: The method of any of aspects 15 through 21, further comprising: receiving a second indication of a second TTI structure different from the TTI structure, the second TTI structure for a second slot allocated for the ambient wireless device communications; transmitting, to the ambient wireless device, the second indication of the second TTI structure; and receiving, from the ambient wireless device in a third quantity of TTIs of the plurality of TTIs, a second backscattered signal of the continuous waveform modulated with second data of the ambient wireless device, the third quantity of TTIs allocated for data from the ambient wireless device according to the second TTI structure.
Aspect 23: The method of any of aspects 15 through 21, further comprising: transmitting, to a second wireless device, the indication of the TTI structure; and receiving, from the second wireless device, an indication of a second TTI structure different from the TTI structure, the second TTI structure associated with the second wireless device and a second plurality of ambient devices.
Aspect 24: The method of aspect 23, further comprising: modifying the TTI structure based at least in part on the indication of the second TTI structure, a relative distance between the first wireless device and the second wireless device, or a combination thereof.
Aspect 25: The method of any of aspects 15 through 24, wherein the TTI structure further indicates at least one TTI of the plurality of TTIs allocated for a synchronization signal dedicated for ambient wireless device communications, the method further comprising: receiving, from a second wireless device in accordance with the TTI structure, the synchronization signal in the at least one TTI of the plurality of TTIs; and synchronizing with the second wireless device using the synchronization signal.
Aspect 26: The method of any of aspects 15 through 25, further comprising: receiving, from the ambient wireless device, an indication of a TTI structure preference based at least in part on the data of the ambient wireless device, an energy status of the ambient wireless device, or a combination thereof.
Aspect 27: A method for wireless communication by a second wireless device, comprising: receiving, from a network entity, an indication of a TTI structure for a slot allocated for ambient wireless device communications, the TTI structure indicating a plurality of TTIs allocated for a plurality of ambient wireless devices; transmitting, to an ambient wireless device of the plurality of ambient wireless devices, the indication of the TTI structure; and transmitting, in a first quantity of TTIs of the plurality of TTIs, a continuous waveform for activation of the ambient wireless device, the first quantity of TTIs allocated for the continuous waveform according to the TTI structure.
Aspect 28: The method of aspect 27, further comprising: receiving, from the network entity, an indication of a frame structure for a set of slots including the slot, the frame structure indicating a respective communication direction for each slot of the set of slots, wherein a subset of slots of the set of slots is allocated for ambient wireless device communications; and transmitting, to the ambient wireless device, the indication of the frame structure for the set of slots.
Aspect 29: The method of aspect 28, further comprising: receiving a bitmap that indicates the subset of slots, wherein each slot of the set of slots is associated with a respective uplink or downlink communication direction in accordance with the frame structure.
Aspect 30: The method of any of aspects 28 through 29, further comprising: receiving a set of bits that indicates a pattern of time-frequency resources for the frame structure, wherein the pattern of time-frequency resources is from a plurality of patterns of time-frequency resources associated with the frame structure.
Aspect 31: The method of any of aspects 28 through 30, wherein at least one slot of the set of slots is allocated for communications between the second wireless device and a first wireless device different from the second wireless device, the method further comprising: receiving, from the first wireless device in the at least one slot, a message indicating a backscattered signal of the ambient wireless device or feedback information associated with the backscattered signal.
Aspect 32: The method of any of aspects 27 through 31, wherein receiving the indication of the TTI structure comprises: receiving the indication of the TTI structure that further indicates the first quantity of TTIs of the plurality of TTIs that are allocated for continuous wave communications, a second quantity of TTIs of the plurality of TTIs that are allocated for forward link data communications, and a third quantity of TTIs of the plurality of TTIs that are allocated for backward link data communications, wherein at least one TTI of the first quantity of TTIs comprises a guard interval between a first TTI of the third quantity of TTIs and a second TTI of the second quantity of TTIs.
Aspect 33: The method of any of aspects 27 through 32, wherein receiving the indication of the TTI structure comprises: receiving a set of bits that indicates a pattern of time-frequency resources for the TTI structure, wherein the pattern of time-frequency resources is from a plurality of patterns of time-frequency resources associated with the TTI structure.
Aspect 34: The method of any of aspects 27 through 33, further comprising: receiving a second indication of a second TTI structure different from the TTI structure, the second TTI structure for a second slot allocated for ambient wireless device communications; and transmitting, to the ambient wireless device, the second indication of the second TTI structure.
Aspect 35: The method of any of aspects 27 through 33, further comprising: transmitting, to a first wireless device, an indication of the TTI structure; and receiving, from the first wireless device, an indication of a second TTI structure different from the TTI structure, the second TTI structure associated with the first wireless device and a second plurality of ambient devices.
Aspect 36: The method of aspect 35, further comprising: modifying the TTI structure based at least in part on the indication of the second TTI structure, a relative distance between the first wireless device and the second wireless device, or a combination thereof.
Aspect 37: The method of any of aspects 27 through 36, wherein the TTI structure further indicates at least one TTI of the plurality of TTIs allocated for a synchronization signal dedicated for ambient wireless device communications, the method further comprising: transmitting, to a first wireless device in accordance with the TTI structure, the synchronization signal in the at least one TTI of the plurality of TTIs; and synchronizing with the first wireless device using the synchronization signal.
Aspect 38: The method of any of aspects 27 through 37, wherein the TTI structure indicates a second quantity of TTIs of the plurality of TTIs allocated for a backscattered signal from the ambient wireless device, the method further comprising: transmitting, to the ambient wireless device in a third quantity of TTIs of the plurality of TTIs, a signal indicating one or more subchannels allocated for the plurality of ambient wireless devices.
Aspect 39: The method of any of aspects 27 through 37, wherein the TTI structure indicates a second quantity of TTIs of the plurality of TTIs allocated for a backscattered signal from the ambient wireless device, the method further comprising: transmitting, to the ambient wireless device in a third quantity of TTIs of the plurality of TTIs, a signal indicating a quantity of repetitions for the backscattered signal.
Aspect 40: An ambient wireless device for wireless communication comprising one or more memories storing processor-executable code; and one or more processors coupled with the one or more memories and individually or collectively operable to execute the code to cause the ambient wireless device to perform a method of any of aspects 1 through 14.
Aspect 41: An ambient wireless device for wireless communication, comprising at least one means for performing a method of any of aspects 1 through 14.
Aspect 42: A non-transitory computer-readable medium storing code for wireless communication, the code comprising instructions executable by one or more processors to perform a method of any of aspects 1 through 14.
Aspect 43: A first wireless device for wireless communication, comprising one or more memories storing processor-executable code; and one or more processors coupled with the one or more memories and individually or collectively operable to execute the code to cause the first wireless device to perform a method of any of aspects 15 through 26.
Aspect 44: A first wireless device for wireless communication, comprising at least one means for performing a method of any of aspects 15 through 26.
Aspect 45: A non-transitory computer-readable medium storing code for wireless communication, the code comprising instructions executable by one or more processors to perform a method of any of aspects 15 through 26.
Aspect 46: A second wireless device for wireless communication, comprising one or more memories storing processor-executable code; and one or more processors coupled with the one or more memories and individually or collectively operable to execute the code to cause the second wireless device to perform a method of any of aspects 27 through 39.
Aspect 47: A second wireless device for wireless communication, comprising at least one means for performing a method of any of aspects 27 through 39.
Aspect 48: A non-transitory computer-readable medium storing code for wireless communication, the code comprising instructions executable by one or more processors to perform a method of any of aspects 27 through 39.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the at least one processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by at least one processor, firmware, or any combination thereof. If implemented using software executed by at least one processor, the functions may be stored as or transmitted using one or more instructions or code of a computer-readable medium. Other examples and implementations are within the scope of the disclosure and appended claims. For example, due to the nature of software, functions described herein may be implemented using software executed by at least one processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An ambient wireless device for wireless communication, comprising:
one or more memories storing processor-executable code; and
one or more processors coupled with the one or more memories and individually or collectively operable to execute the code to cause the ambient wireless device to:
receive an indication of a transmission time interval (TTI) structure for a slot allocated for ambient wireless device communications, the TTI structure indicating a plurality of TTIs allocated for a plurality of ambient wireless devices including the ambient wireless device;
receive, in a first quantity of TTIs of the plurality of TTIs, a continuous waveform for the ambient wireless device, the first quantity of TTIs allocated for continuous waveform communications according to the TTI structure;
modulate the continuous waveform with data of the ambient wireless device; and
send, in a second quantity of TTIs of the plurality of TTIs, a backscattered signal of the continuous waveform modulated with data of the ambient wireless device, the second quantity of TTIs allocated for data from the ambient wireless device according to the TTI structure.

2. The ambient wireless device of claim 1, wherein the one or more processors are individually or collectively further operable to execute the code to cause the ambient wireless device to:
receive an indication of a frame structure for a set of slots including the slot, the frame structure indicating a respective communication direction for each slot of the set of slots, wherein a subset of slots of the set of slots is allocated for the ambient wireless device communications.

3. The ambient wireless device of claim 2, wherein, to receive the indication of the frame structure, the one or more processors are individually or collectively operable to execute the code to cause the ambient wireless device to:
receive the indication of the frame structure within a forward link data packet, the indication comprising a set of control bits of the forward link data packet, wherein the set of control bits further indicates a respective time duration of each slot of the set of slots, a total time duration of the set of slots, one or more frequency resources allocated for data from the ambient wireless device, or a combination thereof.

4. The ambient wireless device of claim 2, wherein the one or more processors are individually or collectively further operable to execute the code to cause the ambient wireless device to:
receive a bitmap that indicates the subset of slots, wherein each slot of the set of slots is associated with a respective uplink or downlink communication direction in accordance with the frame structure.

5. The ambient wireless device of claim 2, wherein the one or more processors are individually or collectively further operable to execute the code to cause the ambient wireless device to:
receive a set of bits that indicates a pattern of time-frequency resources for the frame structure, wherein the pattern of time-frequency resources is from a plurality of patterns of time-frequency resources associated with the frame structure.

6. The ambient wireless device of claim 1, wherein, to receive the indication of the TTI structure, the one or more processors are individually or collectively operable to execute the code to cause the ambient wireless device to:
receive the indication of the TTI structure that further indicates the first quantity of TTIs of the plurality of TTIs that are allocated for continuous wave communications, the second quantity of TTIs of the plurality of TTIs that are allocated for backward link data communications, and a third quantity of TTIs of the plurality of TTIs that are allocated for forward link data communications, the first quantity of TTIs located prior to or subsequent to the second quantity of TTIs in a time domain, wherein at least one TTI of the first quantity of TTIs comprises a guard interval between a first TTI of the third quantity of TTIs and a second TTI of the second quantity of TTIs.

7. The ambient wireless device of claim 1, wherein, to receive the indication of the TTI structure, the one or more processors are individually or collectively operable to execute the code to cause the ambient wireless device to:
receive a bitmap that indicates a pattern of symbols of the slot, the pattern of symbols indicating a subset of symbols of the slot that are allocated for the ambient wireless device communications.

8. The ambient wireless device of claim 1, wherein, to receive the indication of the TTI structure, the one or more processors are individually or collectively operable to execute the code to cause the ambient wireless device to:
receive a set of bits that indicates a pattern of time-frequency resources for the TTI structure, wherein the pattern of time-frequency resources is from a plurality of patterns of time-frequency resources associated with the TTI structure.

9. The ambient wireless device of claim 1, wherein the one or more processors are individually or collectively further operable to execute the code to cause the ambient wireless device to:
receive a second indication of a second TTI structure different from the TTI structure, the second TTI structure for a second slot allocated for the ambient wireless device communications; and
send, in a third quantity of TTIs of the plurality of TTIs, a second backscattered signal of the continuous waveform modulated with second data of the ambient wireless device, the third quantity of TTIs allocated for data from the ambient wireless device according to the second TTI structure.

10. The ambient wireless device of claim 1, wherein the TTI structure further indicates at least one TTI of the plurality of TTIs allocated for a synchronization signal dedicated for ambient wireless device communications, and the one or more processors are individually or collectively further operable to execute the code to cause the ambient wireless device to:
receive, in accordance with the TTI structure, the synchronization signal in the at least one TTI of the plurality of TTIs; and
synchronize with a wireless device using the synchronization signal.

11. The ambient wireless device of claim 1, wherein the one or more processors are individually or collectively further operable to execute the code to cause the ambient wireless device to:
receive, in a third quantity of TTIs of the plurality of TTIs, a signal indicating one or more subchannels allocated for the plurality of ambient wireless devices, wherein the backscattered signal is sent via the one or more subchannels.

12. The ambient wireless device of claim 1, wherein the one or more processors are individually or collectively further operable to execute the code to cause the ambient wireless device to:
receive, in a third quantity of TTIs of the plurality of TTIs, a signal indicating the second quantity of TTIs and a subchannel allocated for the ambient wireless device, wherein the backscattered signal is sent via the subchannel.

13. The ambient wireless device of claim 1, wherein the one or more processors are individually or collectively further operable to execute the code to cause the ambient wireless device to:
receive, in a third quantity of TTIs of the plurality of TTIs, a signal indicating a quantity of repetitions for the backscattered signal, wherein the backscattered signal is sent in accordance with the quantity of repetitions.

14. A first wireless device for wireless communication, comprising:
one or more memories storing processor-executable code; and
one or more processors coupled with the one or more memories and individually or collectively operable to execute the code to cause the first wireless device to:
receive, from a network entity, an indication of a transmission time interval (TTI) structure for a slot allocated for ambient wireless device communications, the TTI structure indicating a plurality of TTIs allocated for a plurality of ambient wireless devices;
transmit, to an ambient wireless device of the plurality of ambient wireless devices, the indication of the TTI structure; and
monitor, in a first quantity of TTIs of the plurality of TTIs, a backscattered signal of a continuous waveform modulated with data of the ambient wireless device, the first quantity of TTIs allocated for backward link communications from the ambient wireless device according to the TTI structure.

15. The first wireless device of claim 14, wherein the one or more processors are individually or collectively further operable to execute the code to cause the first wireless device to:
receive, from the network entity, an indication of a frame structure for a set of slots including the slot, the frame structure indicating a respective communication direction for each slot of the set of slots, wherein a subset of slots of the set of slots is allocated for ambient wireless device communications; and
transmit, to the ambient wireless device, the indication of the frame structure for the set of slots.

16. The first wireless device of claim 15, wherein the one or more processors are individually or collectively further operable to execute the code to cause the first wireless device to:
receive a bitmap that indicates the subset of slots, wherein each slot of the set of slots is associated with a respective uplink or downlink communication direction in accordance with the frame structure; and
transmit the bitmap to the ambient wireless device.

17. The first wireless device of claim 15, wherein the one or more processors are individually or collectively further operable to execute the code to cause the first wireless device to:
receive a set of bits that indicates a pattern of time-frequency resources for the frame structure, wherein the pattern of time-frequency resources is from a plurality of patterns of time-frequency resources associated with the frame structure; and
transmit the set of bits to the ambient wireless device.

18. The first wireless device of claim 15, wherein at least one slot of the set of slots is allocated for communications between the first wireless device and a second wireless device different from the first wireless device, and the one or more processors are individually or collectively further operable to execute the code to cause the first wireless device to:
transmit, to the second wireless device in the at least one slot, a message indicating the backscattered signal of the ambient wireless device or feedback information associated with the backscattered signal.

19. The first wireless device of claim 14, wherein, to receive the indication of the TTI structure, the one or more processors are individually or collectively operable to execute the code to cause the first wireless device to:
receive a set of bits that indicates a pattern of time-frequency resources for the TTI structure, wherein the pattern of time-frequency resources is from a plurality of patterns of time-frequency resources associated with the TTI structure; and
transmit the set of bits to the ambient wireless device.

20. The first wireless device of claim 14, wherein, to receive the indication of the TTI structure, the one or more processors are individually or collectively operable to execute the code to cause the first wireless device to:
receive the indication of the TTI structure that further indicates the first quantity of TTIs of the plurality of TTIs that are allocated for backward link communications, a second quantity of TTIs of the plurality of TTIs that are allocated for forward link data communications, and a third quantity of TTIs of the plurality of TTIs that are allocated for continuous waveform communications, the third quantity of TTIs located prior to or subsequent to the first quantity of TTIs in a time domain, wherein at least one TTI of the third quantity of TTIs comprises a guard interval between a first TTI of the first quantity of TTIs and a second TTI of the second quantity of TTIs.

21. The first wireless device of claim 14, wherein the one or more processors are individually or collectively further operable to execute the code to cause the first wireless device to:
transmit, to a second wireless device, the indication of the TTI structure; and
receive, from the second wireless device, an indication of a second TTI structure different from the TTI structure, the second TTI structure associated with the second wireless device and a second plurality of ambient devices.

22. The first wireless device of claim 14, wherein the TTI structure further indicates at least one TTI of the plurality of TTIs allocated for a synchronization signal dedicated for ambient wireless device communications, and the one or more processors are individually or collectively further operable to execute the code to cause the first wireless device to:
receive, from a second wireless device in accordance with the TTI structure, the synchronization signal in the at least one TTI of the plurality of TTIs; and
synchronize with the second wireless device using the synchronization signal.

23. A second wireless device for wireless communication, comprising:
one or more memories storing processor-executable code; and
one or more processors coupled with the one or more memories and individually or collectively operable to execute the code to cause the second wireless device to:
receive, from a network entity, an indication of a transmission time interval (TTI) structure for a slot allocated for ambient wireless device communications, the TTI structure indicating a plurality of TTIs allocated for a plurality of ambient wireless devices;
transmit, to an ambient wireless device of the plurality of ambient wireless devices, the indication of the TTI structure; and
transmit, in a first quantity of TTIs of the plurality of TTIs, a continuous waveform for activation of the ambient wireless device, the first quantity of TTIs allocated for the continuous waveform according to the TTI structure.

24. The second wireless device of claim 23, wherein the one or more processors are individually or collectively further operable to execute the code to cause the second wireless device to:
receive, from the network entity, an indication of a frame structure for a set of slots including the slot, the frame structure indicating a respective communication direction for each slot of the set of slots, wherein a subset of slots of the set of slots is allocated for ambient wireless device communications; and
transmit, to the ambient wireless device, the indication of the frame structure for the set of slots.

25. The second wireless device of claim 24, wherein the one or more processors are individually or collectively further operable to execute the code to cause the second wireless device to:
receive a bitmap that indicates the subset of slots, wherein each slot of the set of slots is associated with a respective uplink or downlink communication direction in accordance with the frame structure.

26. The second wireless device of claim 24, wherein the one or more processors are individually or collectively further operable to execute the code to cause the second wireless device to:
receive a set of bits that indicates a pattern of time-frequency resources for the frame structure, wherein the pattern of time-frequency resources is from a plurality of patterns of time-frequency resources associated with the frame structure.

27. The second wireless device of claim 24, wherein at least one slot of the set of slots is allocated for communications between the second wireless device and a first wireless device different from the second wireless device, and the one or more processors are individually or collectively further operable to execute the code to cause the second wireless device to:
receive, from the first wireless device in the at least one slot, a message indicating a backscattered signal of the ambient wireless device or feedback information associated with the backscattered signal.

28. The second wireless device of claim 23, wherein, to receive the indication of the TTI structure, the one or more processors are individually or collectively operable to execute the code to cause the second wireless device to:
receive the indication of the TTI structure that further indicates the first quantity of TTIs of the plurality of TTIs that are allocated for continuous wave communications, a second quantity of TTIs of the plurality of TTIs that are allocated for forward link data communications, and a third quantity of TTIs of the plurality of TTIs that are allocated for backward link data communications, wherein at least one TTI of the first quantity of TTIs comprises a guard interval between a first TTI of the third quantity of TTIs and a second TTI of the second quantity of TTIs.

29. The second wireless device of claim 23, wherein, to receive the indication of the TTI structure, the one or more processors are individually or collectively operable to execute the code to cause the second wireless device to:
receive a set of bits that indicates a pattern of time-frequency resources for the TTI structure, wherein the pattern of time-frequency resources is from a plurality of patterns of time-frequency resources associated with the TTI structure.

30. A method for wireless communication by an ambient wireless device, comprising:
receiving an indication of a transmission time interval (TTI) structure for a slot allocated for ambient wireless device communications, the TTI structure indicating a plurality of TTIs allocated for a plurality of ambient wireless devices including the ambient wireless device;
receiving, in a first quantity of TTIs of the plurality of TTIs, a continuous waveform for the ambient wireless device, the first quantity of TTIs allocated for continuous waveform communications according to the TTI structure;
modulating the continuous waveform with data of the ambient wireless device; and
sending, in a second quantity of TTIs of the plurality of TTIs, a backscattered signal of the continuous waveform modulated with data of the ambient wireless device, the second quantity of TTIs allocated for data from the ambient wireless device according to the TTI structure.
